(19) United States
(12) Patent Application Publication
(10) Pub. No.: US 2025/0207073 A1
(43) Pub. Date: Jun. 26, 2025

(54) BEER TASTE BEVERAGE

(71) Applicant: SUNTORY HOLDINGS LIMITED, Osaka-shi, Osaka (JP)

(72) Inventors: Chie Konishi, Fuchu-shi (JP); Taichi Maruhashi, Fuchu-shi (JP); Yuichi Kato, Fuchu-shi (JP)

(73) Assignee: SUNTORY HOLDINGS LIMITED, Osaka-shi, Osaka (JP)

(21) Appl. No.: 18/852,025

(22) PCT Filed: Mar. 28, 2023
(86) PCT No.: PCT/JP2023/012381

§ 371 Date: Sep. 27, 2024

(30) Foreign Application Priority Data
Mar. 31, 2022 (JP) 2022-060162

(51) Int. Cl. C12C 12/00; C12C 5/02

(52) U.S. Cl. CPC C12C 12/00; C12C 5/02

(57) ABSTRACT

Provided is a beer taste beverage which has an alcohol content of 5.0 (v/v) % or less and contains one or more sugars (A) selected from among glucose, sucrose, maltose, isomaltose, maltotriose, and isomaltotriose, wherein the total content of the sugars (A) is 0.07 (w/v) % or more, and which further contains 140 μg/L or less of linalool.

### TECHNICAL FIELD

The present invention relates to a beer-taste beverage, a method for producing a beer-taste beverage, and a method for improving a flavor of a beer-taste beverage.

### BACKGROUND ART

In the related art, various beer-taste beverages have been developed and distributed to the market in response to recent diversified preferences of consumers.

For example, Patent Document 1 discloses a beer-taste beverage containing predetermined amounts of proline and amino nitrogen and having an alcohol content of less than 1% (v/v).

### CITATION LIST

### Patent Document

Patent Document 1: JP 2021-180688 A

### SUMMARY OF INVENTION

### Technical Problem

A beer-taste beverage having a low alcohol content has tended to have insufficient drinking sensation. Thus, there is a demand for a low-alcohol beer-taste beverage having good drinking sensation.

### Solution to Problem

The present invention provides a beer-taste beverage having an alcohol content and a total content of predetermined saccharides greater than or equal to predetermined values and containing linalool in a content less than or equal to a predetermined value. Specifically, the present invention provides the following aspects [1] to [16].

[1]

A beer-taste beverage having an alcohol content less than or equal to 5.0 (v/v) %, the beer-taste beverage containing:
as a saccharide, one or more saccharides (A) selected from the group consisting of glucose, sucrose, maltose, isomaltose, maltotriose, and isomaltotriose, wherein a total content of the one or more saccharides (A) is greater than or equal to 0.07 (w/v) %; and less than or equal to 140 μg/L of linalool.
   [2]

The beer-taste beverage according to [1], wherein the total content of the one or more saccharides (A) is greater than or equal to 0.40 (w/v) % and less than or equal to 3.00 (w/v) %.

[3]

The beer-taste beverage according to [1] or [2], wherein the beer-taste beverage contains one or more saccharides (A1) selected from the group consisting of maltose and maltotriose, and a total content of the one or more saccharides (A1) is greater than or equal to 0.05 (w/v) % and less than or equal to 2.40 (w/v) %.

[4]

The beer-taste beverage according to [3], wherein the total content of the one or more saccharides (A1) is greater than or equal to 0.30 (w/v) % and less than or equal to 2.40 (w/v) %.

[5] The beer-taste beverage according to any one of [1] to [4], wherein a content of T-VDK is less than or equal to 0.300 mass ppm.
[6] The beer-taste beverage according to any one of [1] to [5], wherein a bitterness value of the beer-taste beverage is more than or equal to 1.0 BUs and less than or equal to 40.0 BUs.
[7]

The beer-taste beverage according to any one of [1] to [6], wherein a bitterness value of the beer-taste beverage is less than 35.0 BUs.

[8]

The beer-taste beverage according to any one of [1] to [7], wherein a ratio [alcohol content/saccharides (A)] of the alcohol content (in (v/v) %) to the total content of the one or more saccharides (A) (in (w/v) %) is greater than or equal to 0 and less than or equal to 70.0.

[9]

The beer-taste beverage according to any one of [1] to [8], wherein a ratio [linalool/saccharides (A)] of the content of linalool (in μg/L) to the total content of the one or more saccharides (A) (in (w/v) %) is greater than or equal to 1 and less than or equal to 160.

The beer-taste beverage according to any one of [1] to [9], wherein a ratio [bitterness value/saccharides (A)] of the bitterness value (in BUs) to the total content of the one or more saccharides (A) (in (w/v) %) is greater than or equal to 1 and less than or equal to 200.

The beer-taste beverage according to any one of [1] to [10], wherein a malt proportion of the beer-taste beverage is greater than or equal to 50 mass % and less than or equal to 100 mass %.

The beer-taste beverage according to any one of [1] to [11], wherein the alcohol content is less than or equal to 4.5 (v/v) %.

The beer-taste beverage according to any one of [1] to [12], wherein the alcohol content is less than or equal to 4.0 (v/v) %.

The beer-taste beverage according to any one of [1] to [13], wherein the alcohol content is greater than or equal to 0.5 (v/v) %.

A method for producing a beer-taste beverage, the method including at least:
(I): adjusting an alcohol content to less than or equal to 5.0 (v/v) %;
(II): using, as a saccharide, one or more saccharides (A) selected from the group consisting of glucose, sucrose, maltose, isomaltose, maltotriose, and isomaltotriose, and adjusting a total content of the one or more saccharides (A) to greater than or equal to 0.07 (w/v) %; and
(III): adjusting a content of linalool to less than or equal to 140 μg/L.

A method for improving a flavor of a beer-taste beverage, the method including at least:
operation (I): an operation of adjusting an alcohol content to less than or equal to 5.0 (v/v) %;
operation (II): an operation of using, as a saccharide, one or more saccharides (A) selected from the group consisting of glucose, sucrose, maltose, isomaltose, maltotriose, and isomaltotriose, and adjusting a total content of the one or more saccharides (A) to greater than or equal to 0.07 (w/v) %; and
operation (III): an operation of adjusting a content of linalool to less than or equal to 140 ng/L.

### Advantageous Effects of Invention

A beer-taste beverage according to a preferred aspect of the present invention provides a low-alcohol beer-taste beverage having, for example, drinking sensation suitable for a beer-taste beverage.

A beer-taste beverage according to a more preferred aspect of the present invention provides a low-alcohol beer-taste beverage having drinking sensation suitable for a beer-taste beverage, in which, for example, unsuitable unripe odor and cosmetic aroma are suppressed.

A beer-taste beverage according to an even more preferred aspect of the present invention provides a low-alcohol beer-taste beverage having drinking sensation and crispness suitable for a beer-taste beverage, in which, for example, unsuitable astringency, unripe odor, and cosmetic aroma are suppressed.

### DESCRIPTION OF EMBODIMENTS

For numerical ranges described in the present specification, any combination of upper and lower limits is possible. For example, in a case where “preferably from 30 to 100, more preferably from 40 to 80” is described as a numerical range, a range of “from 30 to 80” and a range of “from 40 to 100” are also included in the numerical range described in the present specification. Further, for example, in a case where a numerical range is described as “preferably greater than or equal to 30, more preferably greater than or equal to 40, and preferably less than or equal to 100, more preferably less than or equal to 80”, a range of “from 30 to 80” and a range of “from 40 to 100” are also included in the numerical range described in the present specification.

In addition, as a numerical range described in the present specification, for example, a description of “from 60 to 100” means a range “greater than or equal to 60 (60 or greater than 60) and less than or equal to 100 (100 or less than 100)”.

### 1. Beer-Taste Beverage

In the present specification, the “beer-taste beverage” refers to an alcohol-containing or non-alcoholic carbonated beverage with a beer-like flavor. That is, unless otherwise specified, the beer-taste beverage in the present specification includes any carbonated beverage having a beer flavor.

Thus, the “beer-taste beverage” includes not only beer and fermented beer-taste beverages, which are malt-fermented beverages produced by fermenting malt, hops, and water as raw materials with yeast, but also carbonated beverages to which a beer flavoring containing a flavor component such as an ester, a higher alcohol, lactone, or the like is added.

Examples of the flavor component contained in the beer flavoring include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, etbyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

In addition, the beer-taste beverage according to an aspect of the present invention may be a fermented beer-taste beverage that has undergone a fermentation step using yeast or may be a non-fermented beer-taste beverage that has not undergone a fermentation step.

The fermented beer-taste beverage may be an ale beer-taste beverage brewed through a fermentation step using a top-fermenting yeast (such as Saccharomyces), a lager beer-taste beverage or a pilsner beer-taste beverage brewed through a fermentation step using a bottom-fermenting yeast (such as Saccharomyces), or a fermented beer-taste beverage produced by using a top-fermenting yeast and a bottom-fermenting yeast at the same fermentation step or separate fermentation steps. The term “fermentation” as used herein may be alcoholic fermentation in which alcohol is produced or non-alcoholic fermentation in which no alcohol is produced.

In addition, the beer-taste beverage of an aspect of the present invention may be a malt-containing beer-taste beverage using malt as a raw material, or may be a malt-free beer-taste beverage not using malt. Examples of the malt-containing beer-taste beverage include barley malt-containing beer-taste beverages.

The beer-taste beverage according to an aspect of the present invention has an alcohol content less than or equal to 5.0 (v/v) %. In the present specification, the “low-alcohol beer-taste beverage” refers to a beer-taste beverage having an alcohol content less than or equal to 5.0 (v/v) %. The beer-taste beverage of an aspect of the present invention may be an alcohol-containing beer-taste beverage having an alcohol content greater than or equal to 1 (v/v) %, or may be a non-alcohol beer-taste beverage having an alcohol content less than 1 (v/v) %.

Note that the non-alcohol beer-taste beverage may be a non-alcohol fermented beer-taste beverage produced by undergoing a fermentation step and then removing alcohol generated in the fermentation step, or may be a non-alcohol non-fermented beer-taste beverage prepared to have a beer-like taste without undergoing a fermentation step. In addition, the non-alcohol beer-taste beverage may be a non-alcohol beer-taste beverage produced by a non-alcoholic fermentation step in which no alcohol is generated.

The alcohol content of the beer-taste beverage according to an aspect of the present invention is adjusted to less than or equal to 5.0 (v/v) %, and thus the beer-taste beverage can be a low-alcohol beer-taste beverage that is likely to cause moderate effect of drinking, and can be a beverage suitable for a consumer who has a feeling of resistance toward an alcoholic beverage.

From the above viewpoint, the alcohol content of the beer-taste beverage of an aspect of the present invention may be less than or equal to 4.8 (v/v) %, less than or equal to 4.6 (v/v) %, less than or equal to 4.5 (v/v) %, less than or equal to 4.4 (v/v) %, less than or equal to 4.3 (v/v) %, less than or equal to 4.2 (v/v) %, less than or equal to 4.1 (v/v) %, less than or equal to 4.0 (v/v) %, less than or equal to 3.9 (v/v) %, less than or equal to 3.8 (v/v) %, less than or equal to 3.7 (v/v) %, less than or equal to 3.6 (v/v) %, less than or equal to 3.5 (v/v) %, less than or equal to 3.4 (v/v) %, less than or equal to 3.3 (v/v) %, less than or equal to 3.2 (v/v) %, less than or equal to 3.1 (v/v) %, less than or equal to 3.0 (v/v) %, less than or equal to 2.9 (v/v) %, less than or equal to 2.8 (v/v) %, less than or equal to 2.7 (v/v) %, less than or equal to 2.6 (v/v) %, less than or equal to 2.5 (v/v) %, less than or equal to 2.4 (v/v) %, less than or equal to 2.3 (v/v) %, less than or equal to 2.2 (v/v) %, less than or equal to 2.1 (v/v) %, less than or equal to 2.0 (v/v) %, less than or equal to 1.8 (v/v) %, less than or equal to 1.6 (v/v) %, less than or equal to 1.5 (v/v) %, less than or equal to 1.4 (v/v) %, less than or equal to 1.3 (v/v) %, less than or equal to 1.2 (v/v) %, less than or equal to 1.1 (v/v) %, less than or equal to 1.0 (v/v) %, less than or equal to 0.9 (v/v) %, less than or equal to 0.8 (v/v) %, less than or equal to 0.7 (v/v) %, less than or equal to 0.6 (v/v) %, less than or equal to 0.5 (v/v) %, or less than 0.5 (v/v) %.

From the viewpoint of producing a low-alcohol beer-taste beverage with better drinking sensation, the alcohol content of the beer-taste beverage according to an aspect of the present invention may be greater than or equal to 0.0 (v/v) %, greater than 0.0 (v/v) %, greater than or equal to 0.1 (v/v) %, greater than or equal to 0.3 (v/v) %, greater than or equal to 0.5 (v/v) %, greater than or equal to 0.7 (v/v) %, greater than or equal to 1.0 (v/v) %, greater than or equal to 1.2 (v/v) %, greater than or equal to 1.4 (v/v) %, greater than or equal to 1.5 (v/v) %, greater than or equal to 1.6 (v/v) %, greater than or equal to 1.8 (v/v) %, greater than or equal to 2.0 (v/v) %, greater than or equal to 2.2 (v/v) %, greater than or equal to 2.4 (v/v) %, greater than or equal to 2.5 (v/v) %, greater than or equal to 2.6 (v/v) %, greater than or equal to 2.7 (v/v) %, greater than or equal to 2.8 (v/v) %, greater than or equal to 2.9 (v/v) %, greater than or equal to 3.0 (v/v) %, greater than or equal to 3.1 (v/v) %, greater than or equal to 3.2 (v/v) %, greater than or equal to 3.3 (v/v) %, or greater than or equal to 3.4 (v/v) %.

Note that in the present specification, the alcohol content is represented by a percentage on a volume/volume basis ((v/v) %). The alcohol content of the beverage can be measured by any known method and can be measured, for example, with a vibrating densimeter.

The alcohol content of the beer-taste beverage according to an aspect of the present invention can be adjusted to a desired range by appropriately setting the addition of diluting water or carbonated water, the addition amount thereof in the case of addition, the types of raw materials (such as barley, malt, corn grits, and sugar solution), the amounts of raw materials, the type of enzyme, the amount of enzyme added, the timing of enzyme addition, the saccharification time in a preparation tank, the protein decomposition time in the preparation tank, the pH in the preparation tank, the pH in a preparation step (wort production step from feeding of malt until before addition of yeast), the amount of the acid to be added used in the pH adjustment, the timing of the pH adjustment (such as at the time of preparation, fermentation, or completion of fermentation, before beer filtration, and after beer filtration), the set temperature and holding time in each temperature region in preparation of wort (including during saccharification), the original extract concentration in a pre-fermentation liquid, the original extract concentration in the fermentation step, the fermentation conditions (such as the oxygen concentration, aeration conditions, yeast species, amount of yeast added, the number of yeast grown, the removal timing of yeast, fermentation temperature, fermentation time, pressure setting, and carbon dioxide concentration), presence or absence of addition of a spirit, a distilled alcohol or the like, the addition amount in the case of addition, and the like.

The beer-taste beverage according to an aspect of the present invention may contain spirits (liquor) derived from grain as an alcohol component to adjust the alcohol content to the range described above.

In the present specification, the “spirits” means an alcoholic beverage produced by saccharifying grain, such as wheat, rice, buckwheat, corn, potato, or sugar cane, as a raw material using malt or, as necessary, an enzymatic agent, fermenting the saccharified product using yeast, and then distilling the fermented product. As the grain which is a raw material of the spirits, a plant belonging to the family Gramineae is preferable, and wheat is more preferable.

Note that the beer-taste beverage according to an aspect of the present invention may be a beverage that does not contain spirits from the viewpoint of producing a beer-like low-alcohol beer-taste beverage having a good taste.

In the beer-taste beverage according to an aspect of the present invention, the alcohol content is adjusted to less than or equal to 5.0 (v/v) % from the viewpoint of producing a low-alcohol beer-taste beverage that is likely to cause moderate effect of drinking. However, when the alcohol content decreases, the drinking sensation suitable for a beer-taste beverage tends to decrease.

Accordingly, the beer-taste beverage according to an aspect of the present invention contains, as a saccharide, one or more saccharides (A) selected from the group consisting of glucose, sucrose, maltose, isomaltose, maltotriose, and isomaltotriose, in which the total content of the one or more saccharides (A) is adjusted to greater than or equal to 0.07 (w/v) %, from the viewpoint of producing a low-alcohol beverage in which moderate effect of drinking is likely to be felt and drinking sensation suitable for a beer-taste beverage is imparted.

The saccharides (A) each are a component capable of imparting drinking sensation suitable for a beer-taste beverage, and when the total content of the one or more saccharides (A) is set to greater than or equal to 0.07 (w/v) %, a low-alcohol beer-taste beverage imparted to which appropriate drinking sensation is imparted can be produced.

Note that the beer-taste beverage of an aspect of the present invention only needs to contain, as a saccharide, one or more kinds of the above-described saccharides (A), and may contain other saccharides not corresponding to the saccharides (A).

In the beer-taste beverage of an aspect of the present invention, the total content of the one or more saccharides (A) is preferably greater than or equal to 0.10 (w/v) %, more preferably greater than or equal to 0.20 (w/v) %, more preferably greater than or equal to 0.30 (w/v) %, more preferably greater than or equal to 0.40 (w/v) %, even more preferably greater than or equal to 0.50 (w/v) %, even more preferably greater than or equal to 0.60 (w/v) %, even more preferably greater than or equal to 0.70 (w/v) %, still even more preferably greater than or equal to 0.80 (w/v) %, and particularly preferably greater than or equal to 0.85 (w/v) %, from the viewpoint of producing a low-alcohol beer-taste beverage having more appropriate drinking sensation.

In the beer-taste beverage of an aspect of the present invention, the total content of the one or more saccharides (A) may be less than or equal to 3.00 (w/v) %, less than or equal to 2.80 (w/v) %, less than or equal to 2.60 (w/v) %, less than or equal to 2.50 (w/v) %, less than or equal to 2.30 (w/v) %, less than or equal to 2.20 (w/v) %, less than or equal to 2.10 (w/v) %, less than or equal to 2.00 (w/v) %, less than or equal to 1.80 (w/v) %, less than or equal to 1.70 (w/v) %, less than or equal to 1.60 (w/v) %, less than or equal to 1.50 (w/v) %, less than or equal to 1.40 (w/v) %, less than 1.30 (w/v) %, less than or equal to 1.25 (w/v) %, or less than or equal to 1.20 (w/v) %.

Note that the beer-taste beverage of an aspect of the present invention only needs to contain, as the saccharides (A), one or more selected from the group consisting of glucose, sucrose, maltose, isomaltose, maltotriose, and isomaltotriose, and from the viewpoint of producing a low-alcohol beer-taste beverage having more appropriate drinking sensation, the beer-taste beverage preferably contains two or more, more preferably contains three or more, even more preferably contains four or more, and still even more preferably contains all six of them.

In addition, from the viewpoint of producing a low-alcohol beer-taste beverage having more appropriate drinking sensation, as the saccharides (A), the beer-taste beverage preferably contains one or more saccharides selected from the group consisting of maltose, isomaltose, maltotriose, and isomaltotriose, more preferably satisfies at least one of the following requirements (I) and (II), and even more preferably satisfies both of the following requirements (I) and (II):
requirement (I): containing one or more saccharides (A1) selected from the group consisting of maltose and maltotriose; and
requirement (II): containing one or more saccharides (A2) selected from the group consisting of isomaltose and isomaltotriose.

In the beer-taste beverage according to an aspect of the present invention, the total content of the one or more saccharides (A1) selected from the group consisting of maltose and maltotriose is preferably greater than or equal to 0.05 (w/v) %, more preferably greater than or equal to 0.08 (w/v) %, more preferably greater than or equal to 0.10 (w/v) %, more preferably greater than or equal to 0.20 (w/v) %, even more preferably greater than or equal to 0.30 (w/v) %, even more preferably greater than or equal to 0.40 (w/v) %, even more preferably greater than or equal to 0.50 (w/v) %, still even more preferably greater than or equal to 0.60 (w/v) %, and particularly preferably greater than or equal to 0.65 (w/v) %, and may be greater than or equal to 0.70 (w/v) %, greater than or equal to 0.75 (w/v) %, greater than or equal to 0.80 (w/v) %, greater than or equal to 0.85 (w/v) %, or greater than or equal to 0.90 (w/v) %, from the viewpoint of producing a low-alcohol beer-taste beverage having more appropriate drinking sensation.

The total content of the one or more saccharides (A1) in the beer-taste beverage of an aspect of the present invention may be less than or equal to 2.40 (w/v) %, less than or equal to 2.20 (w/v) %, less than or equal to 2.00 (w/v) %, less than or equal to 1.90 (w/v) %, less than or equal to 1.80 (w/v) %, less than or equal to 1.70 (w/v) %, less than or equal to 1.60 (w/v) %, less than or equal to 1.50 (w/v) %, less than or equal to 1.40 (w/v) %, less than or equal to 1.30 (w/v) %, less than or equal to 1.20 (w/v) %, less than or equal to 1.10 (w/v) %, less than or equal to 1.00 (w/v) %, less than or equal to 0.95 (w/v) %, or less than or equal to 0.90 (w/v) %.

In the beer-taste beverage according to an aspect of the present invention, the total content of the one or more saccharides (A2) selected from the group consisting of isomaltose and isomaltotriose is preferably greater than or equal to 0.005 (w/v) %, more preferably greater than or equal to 0.007 (w/v) %, more preferably greater than or equal to 0.010 (w/v) %, more preferably greater than or equal to 0.020 (w/v) %, even more preferably greater than or equal to 0.030 (w/v) %, even more preferably greater than or equal to 0.040 (w/v) %, even more preferably greater than or equal to 0.050 (w/v) %, still even more preferably greater than or equal to 0.060 (w/v) %, and particularly preferably greater than or equal to 0.065 (w/v) %, and may be greater than or equal to 0.070 (w/v) %, greater than or equal to 0.075 (w/v) %, greater than or equal to 0.080 (w/v) %, greater than or equal to 0.085 (w/v) %, or greater than or equal to 0.090 (w/v) %, from the viewpoint of producing a low-alcohol beer-taste beverage having more appropriate drinking sensation.

The total content of the one or more saccharides (A2) in the beer-taste beverage of an aspect of the present invention may be less than or equal to 1.400 (w/v) %, less than or equal to 1.200 (w/v) %, less than or equal to 1.000 (w/v) %, less than or equal to 0.800 (w/v) %, less than or equal to 0.600 (w/v) %, less than or equal to 0.500 (w/v) %, less than or equal to 0.400 (w/v) %, less than or equal to 0.300 (w/v) %, less than or equal to 0.200 (w/v) %, less than or equal to 0.100 (w/v) %, less than or equal to 0.095 (w/v) %, or less than or equal to 0.090 (w/v) %.

In the beer-taste beverage of an aspect of the present invention, from the viewpoint of producing a low-alcohol beer-taste beverage in which feeling of effect of drinking and appropriate drinking sensation are improved in a well-balanced manner, the ratio [alcohol content/saccharides (A)] of the alcohol content (in (v/v) %) to the total content of the one or more saccharides (A) (in (w/v) %) is preferably greater than or equal to 0, more preferably greater than or equal to 0.10, more preferably greater than or equal to 0.30, more preferably greater than or equal to 0.50, more preferably greater than or equal to 0.70, even more preferably greater than or equal to 0.90, even more preferably greater than or equal to 1.00, even more preferably greater than or equal to 1.20, still even more preferably greater than or equal to 1.50, and particularly preferably greater than or equal to 1.70, and may be greater than or equal to 2.00, greater than or equal to 2.20, greater than or equal to 2.30, greater than or equal to 2.40, greater than or equal to 2.50, greater than or equal to 2.60, greater than or equal to 2.70, greater than or equal to 2.80, greater than or equal to 2.90, greater than or equal to 3.00, greater than or equal to 3.10, greater than or equal to 3.20, greater than or equal to 3.30, or greater than or equal to 3.40, and preferably less than or equal to 70.0, more preferably less than or equal to 65.0, more preferably less than or equal to 60.0, more preferably less than or equal to 55.0, more preferably less than or equal to 50.0, even more preferably less than or equal to 45.0, even more preferably less than or equal to 40.0, even more preferably less than or equal to 35.0, still even more preferably less than or equal to 30.0, and particularly preferably less than or equal to 25.0, and may be less than or equal to 20.0, less than or equal to 15.0, less than or equal to 12.0, less than or equal to 10.0, less than or equal to 9.0, less than or equal to 8.0, less than or equal to 7.0, less than or equal to 6.5, less than or equal to 6.0, less than or equal to 5.5, less than or equal to 5.0, or less than or equal to 4.5.

Note that in the present specification, the contents of the saccharides (A), the saccharides (A1), and the saccharides (A2) (hereinafter also referred to as “the contents of the saccharides (A) and the like”) can be measured by, for example, high-performance liquid chromatography (HPLC).

The contents of the saccharides (A) and the like in the beer-taste beverage of an aspect of the present invention can be adjusted to desired contents by adjusting the amounts and proportions of sweeteners such as liquid sugar containing the saccharides (A) (including the saccharides (A1) and the saccharides (A2)) and grain as raw materials, the type of enzyme (type of enzyme-containing raw material and the like), the amount of enzymes added, the timing of enzyme addition, the set temperature and holding time in each temperature region in preparing the saccharified liquid, the fermentation conditions (such as yeast species, amount of yeast added, the addition timing of yeast, the removal timing of yeast, the timing of reducing the yeast amount, the number of yeast grown, yeast growth time, yeast activity, the size of yeast (cell size), oxygen concentration, carbon dioxide concentration, nitrogen concentration, fermentation temperature, fermentation time, and pressure setting), and the like.

Meanwhile, a beer-taste beverage having a high content of the above-described saccharides (A) has a problem in that the beer-taste beverage tends to have a strong sticky feeling, and unripe odor unsuitable for a beer-taste beverage is likely to be generated and the beverage lacks a refreshing feeling when taken.

Accordingly, the beer-taste beverage according to an aspect of the present invention contains linalool, which masks and suppresses such unripe odor unsuitable for a beer-taste beverage to adjust the beverage to a low-alcohol beverage more befitting a beer-taste beverage. However, when a large amount of linalool is contained, the beverage is likely to have cosmetic aroma unsuitable for a beer-taste beverage.

From the viewpoint of producing a low-alcohol beverage in which such cosmetic aroma unsuitable for a beer-taste beverage is effectively suppressed, the content of the linalool is limited to 140 μg/L or less in the beer-taste beverage of an aspect of the present invention.

In the beer-taste beverage of an aspect of the present invention, from the viewpoint of producing a low-alcohol beer-taste beverage in which unsuitable cosmetic aroma is effectively suppressed, the content of linalool is less than or equal to 140 μg/L, preferably less than or equal to 130 μg/L, more preferably less than or equal to 120 μg/L, more preferably less than or equal to 110 μg/L, even more preferably less than or equal to 100 g/L, even more preferably less than or equal to 90 μg/L, still even more preferably less than or equal to 80 μg/L, and particularly preferably less than or equal to 70 μg/L, and may be less than or equal to 60 μg/L, less than or equal to 50 μg/L, less than or equal to 45 g/L, less than or equal to 40 μg/L, less than or equal to 39 μg/L, less than or equal to 38 μg/L, less than or equal to 37 μg/L, less than or equal to 36 μg/L, less than or equal to 35 μg/L, less than or equal to 34 μg/L, less than or equal to 33 μg/L, less than or equal to 32 μg/L, less than or equal to 31 μg/L, less than or equal to 30 μg/L, less than or equal to 29 μg/L, less than or equal to 28 ng/L, less than or equal to 27 μg/L, less than or equal to 26 μg/L, less than or equal to 25 μg/L, less than or equal to 24 μg/L, less than or equal to 23 μg/L, less than or equal to 22 μg/L, less than or equal to 21 μg/L, less than or equal to 20 μg/L, less than or equal to 19 μg/L, less than or equal to 18 μg/L, less than or equal to 17 μg/L, less than or equal to 16 μg/L, or less than or equal to 15 μg/L.

In the beer-taste beverage according to an aspect of the present invention, from the viewpoint of suppressing unsuitable unripe odor and making a low-alcohol beverage more befitting a beer-taste beverage, the content is preferably greater than or equal to 0.01 g/L, more preferably greater than or equal to 0.05 μg/L, more preferably greater than or equal to 0.07 μg/L, even more preferably greater than or equal to 0.10 μg/L, even more preferably greater than or equal to 0.30 μg/L, still even more preferably greater than or equal to 0.50 μg/L, and particularly preferably greater than or equal to 1.0 μg/L, and may be greater than or equal to 1.5 g/L, greater than or equal to 2.0 μg/L, greater than or equal to 2.5 μg/L, greater than or equal to 3.0 μg/L, greater than or equal to 3.5 g/L, greater than or equal to 4.0 μg/L, greater than or equal to 4.5 μg/L, greater than or equal to 5.0 μg/L, greater than or equal to 5.5 μg/L, greater than or equal to 6.0 μg/L, greater than or equal to 6.5 μg/L, or greater than or equal to 7.0 μg/L.

In the beer-taste beverage of an aspect of the present invention, the ratio [content of linalool/content of saccharides (A)] of the content of linalool (in μg/L) to the content of the saccharides (A) (in (w/v) %) is preferably greater than or equal to 1, more preferably greater than or equal to 2, more preferably greater than or equal to 3, more preferably greater than or equal to 4, even more preferably greater than or equal to 5, even more preferably greater than or equal to 6, even more preferably greater than or equal to 7, still even more preferably greater than or equal to 8, and particularly preferably greater than or equal to 8.5, from the viewpoint of producing a low-alcohol beer-taste beverage in which unsuitable unripe odor is effectively suppressed, and preferably less than or equal to 200, more preferably less than or equal to 150, more preferably less than or equal to 100, more preferably less than or equal to 90, even more preferably less than or equal to 80, even more preferably less than or equal to 70, even more preferably less than or equal to 60, still even more preferably less than or equal to 50, still even more preferably less than or equal to 40, and particularly preferably less than or equal to 30, from the viewpoint of producing a low-alcohol beer-taste beverage in which inappropriate cosmetic aroma is more effectively suppressed.

Note that the content of linalool can be measured using a gas chromatograph-mass spectrometer (GC-MS) described in J. Agric. Food Chem., 2013, 61 (47), pp. 11303 to 11311 (Characterization of the Key Aroma Compounds in Two Bavarian Wheat Beers by Means of the Sensomics Approach).

In addition, in the beer-taste beverage according to an aspect of the present invention, the content of linalool can be controlled by, for example, adjusting the amount of linalool added, or adjusting the type and amount of a raw material having a high content of linalool (for example, hops or the like), the addition timing of the raw material, and the like.

In the beer-taste beverage of an aspect of the present invention, from the viewpoint of producing a low-alcohol beer-taste beverage having more appropriate drinking sensation, the content of T-VDK (total vicinal diketones) is preferably less than or equal to 0.300 mass ppm, more preferably less than or equal to 0.250 mass ppm, more preferably less than or equal to 0.220 mass ppm, more preferably less than or equal to 0.200 mass ppm, still more preferably less than or equal to 0.190 mass ppm, more preferably less than or equal to 0.180 mass ppm, still even more preferably less than or equal to 0.170 mass ppm, even more preferably less than or equal to 0.160 mass ppm, still even more preferably less than or equal to 0.150 mass ppm, even more preferably less than or equal to 0.140 mass ppm, still even more preferably less than or equal to 0.130 mass ppm, even more preferably less than or equal to 0.120 mass ppm, still even more preferably less than or equal to 0.110 mass ppm, still even more preferably less than or equal to 0.100 mass ppm, and particularly preferably less than or equal to 0.090 mass ppm, and may be less than or equal to 0.080 mass ppm, less than or equal to 0.070 mass ppm, or less than or equal to 0.060 mass ppm, based on the total amount (100 mass %) of the beer-taste beverage.

In the beer-taste beverage according to an aspect of the present invention, from the viewpoint of producing a low-alcohol beer-taste beverage having a strong impact when taken, the content of T-VDK (total vicinal diketones) is preferably greater than or equal to 0.001 mass ppm, more preferably greater than or equal to 0.003 mass ppm, more preferably greater than or equal to 0.005 mass ppm, more preferably greater than or equal to 0.007 mass ppm, more preferably greater than or equal to 0.010 mass ppm, even more preferably greater than or equal to 0.012 mass ppm, even more preferably greater than or equal to 0.014 mass ppm, even more preferably greater than or equal to 0.016 mass ppm, still even more preferably greater than or equal to 0.018 mass ppm, and particularly preferably greater than or equal to 0.020 mass ppm, and may be greater than or equal to 0.025 mass ppm, greater than or equal to 0.030 mass ppm, or greater than or equal to 0.035 mass ppm, based on the total amount (100 mass %) of the beer-taste beverage.

Note that in the present specification, the content of T-VDK (total vicinal diketones) can be measured by the method described in “8.16 Diacetyl” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The content of T-VDK (total vicinal diketones) can be controlled by appropriately adjusting the conditions during the saccharification treatment (such as saccharification temperature, saccharification time, and pH during saccharification), the pH of the pre-fermentation liquid (wort before addition of yeast), the sugar composition of the pre-fermentation liquid, the amino acid composition of the pre-fermentation liquid, the acid composition of the pre-fermentation liquid, the original extract of the pre-fermentation liquid, the conditions during the fermentation treatment (such as the number of yeasts added, aeration condition, fermentation temperature, fermentation time, and pressurization conditions), and the conditions (such as the number of yeasts during the aging treatment, aging temperature, and aging time) during the aging treatment performed on the fermented liquid produced through the fermentation step. Alternatively, the content of VDK may be adjusted by direct addition of VDK.

In the beer-taste beverage according to an aspect of the present invention, the bitterness value is preferably greater than or equal to 1.0 BUs, more preferably greater than or equal to 2.0 BUs, more preferably greater than or equal to 3.0 BUs, more preferably greater than or equal to 5.0 BUs, even more preferably greater than or equal to 7.0 BUs, even more preferably greater than or equal to 9.0 BUs, even more preferably greater than or equal to 10.0 BUs, still even more preferably greater than or equal to 12.0 BUs, still even more preferably greater than or equal to 13.0 BUs, still even more preferably greater than or equal to 14.0 BUs, and particularly preferably greater than or equal to 15.0 BUs, from the viewpoint of producing a low-alcohol beer-taste beverage having appropriate crispness, and preferably less than or equal to 40.0 BUS, more preferably less than or equal to 35.0 BUs, more preferably less than 35.0 BUs, more preferably less than or equal to 34.0 BUs, more preferably less than or equal to 33.0 BUs, more preferably less than or equal to 32.0 BUs, even more preferably less than or equal to 31.0 BUS, even more preferably less than or equal to 30.0 BUs, even more preferably less than 30.0 BUS, even more preferably less than or equal to 29.0 BUs, even more preferably less than or equal to 28.0 BUs, still even more preferably less than or equal to 27.0 BUs, still even more preferably less than or equal to 26.0 BUs, and particularly preferably less than or equal to 25.0 BUs, from the viewpoint of producing a low-alcohol beer-taste beverage having effectively suppressed astringency unsuitable for a beer-taste beverage.

In the beer-taste beverage of an aspect of the present invention, the ratio [bitterness value/saccharides (A)] of the bitterness value (in BUs) to the total content of the one or more saccharides (A) (in (w/v) %) is preferably greater than or equal to 1, more preferably greater than or equal to 3, more preferably greater than or equal to 5, more preferably greater than or equal to 7, even more preferably greater than or equal to 10, even more preferably greater than or equal to 12, even more preferably greater than or equal to 14, still even more preferably greater than or equal to 16, and particularly preferably greater than or equal to 18, from the viewpoint of producing a low-alcohol beer-taste beverage having more improved crispness, and preferably less than or equal to 200, more preferably less than or equal to 180, more preferably less than or equal to 160, more preferably less than or equal to 140, even more preferably less than or equal to 120, even more preferably less than or equal to 100, even more preferably less than or equal to 80, still even more preferably less than or equal to 60, and particularly preferably less than or equal to 40, from the viewpoint of producing a low-alcohol beer-taste beverage having effectively suppressed astringency unsuitable for a beer-taste beverage and more appropriate drinking sensation.

In the present specification, the “bitterness value” of the beverage can be measured by the measurement method described in “8.15 Bitterness Value” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The bitterness value of the beer-taste beverage according to an aspect of the present invention is an index of the bitterness imparted by a hop-derived component containing isohumulone as a main component, and can be controlled by, for example, appropriately adjusting the type, amount, and addition timing of hops.

In the beer-taste beverage of an aspect of the present invention, the total polyphenol amount is preferably greater than or equal to 10 mass ppm, more preferably greater than or equal to 20 mass ppm, more preferably greater than or equal to 30 mass ppm, even more preferably greater than or equal to 40 mass ppm, even more preferably greater than or equal to 50 mass ppm, still even more preferably greater than or equal to 60 mass ppm, and particularly preferably greater than or equal to 70 mass ppm, and preferably less than or equal to 500 mass ppm, more preferably less than or equal to 400 mass ppm, more preferably less than or equal to 350 mass ppm, more preferably less than or equal to 300 mass ppm, even more preferably less than or equal to 250 mass ppm, even more preferably less than or equal to 200 mass ppm, still even more preferably less than or equal to 180 mass ppm, and particularly preferably less than or equal to 160 mass ppm, from the viewpoint of producing a low-alcohol beer-taste beverage in which appropriate drinking sensation and crispness are improved in a well-balanced manner.

The “total polyphenol amount” in the present specification is the total amount of polyphenols contained in the total amount (100 mass %) of the beer-taste beverage.

The polyphenol means a compound in which two or more hydrogens of an aromatic hydrocarbon are substituted with a hydroxyl group, and specific examples thereof include flavonol, isoflavone, tannin, catechin, quercetin, and anthocyanin.

In addition, in the present specification, the total polyphenol amount can be measured, for example, by a method described in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013).

The total polyphenol amount can be controlled by adjusting the usage amount of a raw material with a high polyphenol content, such as barley malt or malt husks (hulls).

In general, malt with husks (hulls) or the like has a high polyphenol content, and soybeans, yeast extract, wheat, wheat malt, and the like have a low polyphenol content. The polyphenol content can be adjusted to a desired range by appropriately selecting such a raw material and adjusting the usage amount thereof.

In the beer-taste beverage according to an aspect of the present invention, the sugar content may be greater than or equal to 0.5 g/100 mL, greater than or equal to 0.6 g/100 mL, greater than or equal to 0.7 g/100 mL, greater than or equal to 0.8 g/100 mL, greater than or equal to 0.9 g/100 mL, greater than or equal to 1.0 g/100 mL, greater than or equal to 1.1 g/100 mL, greater than or equal to 1.2 g/100 mL, greater than or equal to 1.3 g/100 mL, greater than or equal to 1.4 g/100 mL, greater than or equal to 1.5 g/100 mL, greater than or equal to 1.6 g/100 mL, greater than or equal to 1.7 g/100 mL, greater than or equal to 1.8 g/100 mL, greater than or equal to 1.9 g/100 mL, or greater than or equal to 2.0 g/100 mL, and may be less than or equal to 4.0 g/100 mL, less than or equal to 3.9 g/100 mL, less than or equal to 3.8 g/100 mL, less than or equal to 3.7 g/100 mL, less than or equal to 3.6 g/100 mL, less than or equal to 3.5 g/100 mL, less than or equal to 3.4 g/100 mL, less than or equal to 3.3 g/100 mL, less than or equal to 3.2 g/100 mL, less than or equal to 3.1 g/100 mL, or less than or equal to 3.0 g/100 mL.

Note that the sugar content can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the timing of enzyme addition, the saccharification time, the pH during saccharification, the pH in the preparation step (wort production step from feeding of malt until before addition of yeast), the time for wort filtration, the set temperature and holding time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, carbon dioxide concentration, amount of enzyme added, type of enzyme, and addition amount of enzyme), and the like.

In addition, the “sugar” in the present specification refers to a sugar based on the Nutrition Labeling Standards for Foods (Ministry of Health, Labour and Welfare Notification No. 176, 2003, Consumer Affairs Agency Notification No. 8, Partial Revision, Sep. 27, 2013) and specifically means a material in which protein, lipid, dietary fiber, ash, alcohol content, and water have been removed from the target food. Thus, the amount of sugar in a food can be calculated by subtracting the amounts of protein, lipid, dietary fiber, ash, and water from the weight of the food.

Here, the amounts of protein, lipid, dietary fiber, ash, and water can be measured by the methods described in the Nutrition Labeling Standards. Specifically, the amount of protein can be measured by a method of quantitative conversion of nitrogen, the amount of lipid can be measured by an ether extraction method, the amount of dietary fiber can be measured by the Prosky method, the amount of ash can be measured by a direct ashing method, and the amount of water can be measured by a method of heating and drying under reduced pressure.

In the beer-taste beverage according to an aspect of the present invention, the apparent fermentation degree may be greater than or equal to 56%, greater than or equal to 58%, greater than or equal to 60%, greater than or equal to 61%, greater than or equal to 62%, greater than or equal to 63%, greater than or equal to 64%, greater than or equal to 65%, greater than or equal to 66%, greater than or equal to 67%, greater than or equal to 68%, greater than or equal to 69%, greater than or equal to 70%, greater than or equal to 71%, greater than or equal to 72%, greater than or equal to 73%, greater than or equal to 74%, or greater than or equal to 75%, or may be less than or equal to 92%, less than or equal to 90%, less than 90%, less than or equal to 88%, less than or equal to 86%, less than or equal to 85%, or less than or equal to 84%.

Note that the apparent fermentation degree can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the temperature in enzymatic reaction, the timing of enzyme addition, the saccharification time, the pH during saccharification, the temperature during saccharification, the pH in the preparation step (wort production step from feeding of malt until before addition of yeast), the temperature in the preparation step, the time for wort filtration, the set temperature and holding time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, carbon dioxide concentration, amount of enzyme added, type of enzyme, and timing of enzyme addition), and the like.

In the present specification, the “apparent fermentation degree” means the proportion of the concentration of sugar that can be consumed by yeast as a nutrient source for alcoholic fermentation to the total concentration of sugar contained in the pre-fermentation liquid. For example, the apparent fermentation degree AA of the beer-taste beverage can be calculated from Equation (1) below.

$$AA ( \% ) = 100 \times ( P - Es ) / P \qquad Equation ( 1 )$$

In Equation (1) above, “P” is an original extract (original wort extract) and can be measured by the method described in “BCOJ Beer Analysis Method” (published by The Brewing Society of Japan, edited by Brewers Association of Japan, revised edition of Nov. 1, 2004).

In addition, “Es” represents an apparent extract of the beer-taste beverage. The apparent extract can be calculated, for example, from Equation (2) below as described in “BCOJ Beer Analysis Method” (published by The Brewing Society of Japan, edited by Brewers Association of Japan, revised edition of Nov. 1, 2004).

$$Es = - 460.234 + 662.649 \times D - 202.414 \times D 2 \qquad Equation ( 2 )$$

In Equation (2), D is the specific gravity of a degassed beer-taste beverage.

The apparent extract “Es” may have a negative value depending on D in Equation (2), and thus the calculated apparent fermentation degree may exceed 100%.

The original wort extract (O-Ex) concentration of the beer-taste beverage according to an aspect of the present invention is preferably greater than or equal to 6.0 mass %, more preferably greater than or equal to 6.5 mass %, more preferably greater than or equal to 7.0 mass %, even more preferably greater than or equal to 7.5 mass %, even more preferably greater than or equal to 8.0 mass %, still even more preferably greater than or equal to 8.5 mass %, and particularly preferably greater than or equal to 9.0 mass %, and preferably less than or equal to 20.0 mass %, more preferably less than or equal to 18.0 mass %, even more preferably less than or equal to 16.0 mass %, still even more preferably less than or equal to 15.0 mass %, and particularly preferably less than or equal to 13.5 mass %.

The “original wort extract concentration” in the present specification can be measured by the method described in “BCOJ Beer Analysis Method” (published by The Brewing Society of Japan, edited by Brewers Association of Japan, revised edition of Nov. 1, 2004).

The malt proportion of the beer-taste beverage according to an aspect of the present invention may be greater than or equal to 10 mass %, greater than or equal to 20 mass %, greater than or equal to 30 mass %, greater than or equal to 40 mass %, greater than or equal to 50 mass %, greater than or equal to 55 mass %, greater than or equal to 60 mass %, greater than or equal to 65 mass %, greater than or equal to 66 mass %, greater than 66 mass %, greater than or equal to 67 mass %, greater than or equal to 70 mass %, greater than or equal to 75 mass %, greater than or equal to 80 mass %, greater than or equal to 85 mass %, greater than or equal to 90 mass %, greater than or equal to 95 mass %, or 100 mass %, and less than or equal to 100 mass %, less than 100 mass %, less than or equal to 98 mass %, less than or equal to 95 mass %, less than or equal to 90 mass %, less than or equal to 85 mass %, less than or equal to 80 mass %, less than or equal to 75 mass %, less than or equal to 70 mass %, less than or equal to 68 mass %, less than or equal to 67 mass %, or less than or equal to 66 mass %.

In the present specification, the “malt proportion” means a value calculated according to the Interpretation Notice on the Liquor Tax Law and the Administrative Ordinance Related to Alcoholic Beverages and the like enforced on Apr. 1, 2018.

Note that in a case of suppressing the malt proportion, it is preferable to increase amounts of raw materials (carbon source and nitrogen source) other than malt, which can be utilized by yeast. Examples of the carbon source of the raw material that can be utilized by yeast include monosaccharides, disaccharides, trisaccharides, and sugar solutions thereof, and examples of the nitrogen source include yeast extract, soybean protein, malt, soybean, yeast extract, pea, wheat malt, ungerminated grains, and decomposition products thereof. Examples of the ungerminated grains include barley, wheat, rye, common wild oat, oat, adlay, rice (such as white rice and brown rice), corn, kaoliang, potato, legumes (such as soybean and pea), buckwheat, sorghum, foxtail millet, and Japanese millet, which are ungerminated. In addition, starches collected from these grains and extracts thereof may be used.

The beer-taste beverage according to an aspect of the present invention may be beer.

In the present specification, the “beer” means a beverage produced by using malt, hops, and water as raw materials and fermenting them with yeast, and specifically means one defined by the Interpretation Notice on the Liquor Tax Law and the Administrative Ordinance Related to Alcoholic Beverages and the like enforced on Apr. 1, 2018.

That is, in a case where the beer-taste beverage according to an aspect of the present invention is beer, the alcohol content is adjusted by the fermentation step using yeast.

The color of the beer-taste beverage according to an aspect of the present invention is not particularly limited, and may be amber or golden like ordinary beer, black like dark beer, or colorless and transparent, or may be colored as desired by adding a coloring agent or the like. The color of the beer-taste beverage can be determined by the naked eye, but may be defined by the total light transmittance, chromaticity, or the like.

The chromaticity of the beer-taste beverage according to an aspect of the present invention may be greater than or equal to 0.1 EBC, greater than 1.0 EBC, greater than or equal to 2.0 EBC, greater than or equal to 3.0 EBC, greater than or equal to 4.0 EBC, greater than or equal to 5.0 EBC, greater than or equal to 6.0 EBC, greater than or equal to 6.5 EBC, greater than or equal to 7.0 EBC, greater than or equal to 7.5 EBC, greater than or equal to 8.0 EBC, greater than or equal to 8.5 EBC, greater than or equal to 9.0 EBC, greater than or equal to 9.5 EBC, greater than or equal to 10.0 EBC, greater than or equal to 10.5 EBC, greater than or equal to 11.0 EBC, greater than or equal to 11.5 EBC, greater than or equal to 12.0 EBC, greater than or equal to 12.5 EBC, or greater than or equal to 13.0 EBC, and may be less than or equal to 500 EBC, less than or equal to 450 EBC, less than or equal to 400 EBC, less than or equal to 350 EBC, less than or equal to 300 EBC, less than or equal to 270 EBC, less than or equal to 250 EBC, less than or equal to 220 EBC, less than or equal to 200 EBC, less than or equal to 180 EBC, less than or equal to 160 EBC, less than or equal to 140 EBC, less than or equal to 120 EBC, less than or equal to 100 EBC, less than or equal to 80 EBC, less than or equal to 70 EBC, less than or equal to 60 EBC, less than or equal to 50 EBC, less than or equal to 40 EBC, less than or equal to 35 EBC, less than or equal to 30 EBC, less than or equal to 27 EBC, less than or equal to 25 EBC, less than or equal to 23 EBC, less than or equal to 20 EBC, less than or equal to 18 EBC, less than or equal to 16 EBC, or less than or equal to 15 EBC.

In the present specification, the “chromaticity” of the beer-taste beverage can be measured by the measurement method described in “8.8 Chromaticity” in Revised BCOJ Beer Analysis Method (published by Public Interest Incorporated Foundation, The Brewing Society of Japan, edited by Analysis Committee, Brewery Convention of Japan, Brewers Association of Japan, Enlarged and Revised Edition of 2013). The “chromaticity” of the beer-taste beverage is specified by the unit of chromaticity (EBC unit) defined by the European Brewery Convention. A beverage with a smaller numerical value has a lighter and brighter color, whereas a beverage with a larger numerical value has a deeper and darker color.

In addition, the chromaticity of the beer-taste beverage according to an aspect of the present invention can be controlled, for example, by appropriately adjusting the type of malt used, the blending proportion in a case of using two or more types of malts in combination, the boiling conditions for preparation of the pre-fermentation liquid, or like. More specifically, for example, to increase the chromaticity of the beer-taste beverage, the chromaticity can be adjusted by increasing the blending proportion of dark malt as the malt, increasing the temperature during boiling treatment, increasing boiling time, performing decoction during preparation of a saccharified liquid, and the like. Furthermore, the chromaticity can also be adjusted to a higher level by increasing the original wort extract concentration or increasing the malt proportion.

The pH of the beer-taste beverage according to an aspect of the present invention is preferably greater than or equal to 2.0, greater than or equal to 2.2, greater than or equal to 2.4, greater than or equal to 2.6, greater than or equal to 2.8, greater than or equal to 3.0, greater than or equal to 3.1, greater than or equal to 3.2, greater than or equal to 3.3, greater than or equal to 3.4, greater than or equal to 3.5, greater than or equal to 3.6, greater than or equal to 3.7, greater than or equal to 3.8, greater than or equal to 3.9, or greater than or equal to 4.0, and preferably less than or equal to 5.4, less than or equal to 5.2, less than or equal to 5.0, less than or equal to 4.9, less than or equal to 4.8, less than or equal to 4.7, less than or equal to 4.6, less than or equal to 4.55, less than or equal to 4.5, less than or equal to 4.4, less than or equal to 4.3, less than or equal to 4.2, or less than or equal to 4.1.

The beer-taste beverage of an aspect of the present only needs to be a mode in which the beverage is filled in a container, and examples of the container include a bottle, a PET bottle, a can, and a barrel. In particular, from the viewpoint of easy portability, the container is preferably a can, a bottle, or a PET bottle.

### 1.1 Raw Materials

As the main raw material of the beer-taste beverage of an aspect of the present invention, malt may be used together with water, or malt does not need to be used. Furthermore, the beer-taste beverage according to an aspect of the present invention may be a beverage using hops as a raw material, or may be a beverage not using hops.

Besides, a preservative, a sweetener, a water-soluble dietary fiber, a bittering agent or bitterness-imparting agent, an antioxidant, a flavoring, an acidulant, a salt, and/or the like may be used.

1.1.1 Malt, Grain Other than Malt

In a case where malt is used as the raw material, the malt refers to malt prepared by germinating seeds of barley or the like, such as barley, wheat, rye, common wild oat, oat, or adlay, drying the germinated seeds, and removing roots, and may be from any production area and of any variety.

The malt used in an embodiment of the present invention is preferably barley malt. Barley malt is one of the malts most commonly used as a raw material for Japanese beer-taste beverages. There are several types of barley, such as two-rowed barley and six-rowed barley, and any of them may be used. Furthermore, in addition to ordinary malt, colored malt or the like can also be used. When colored malt is used, different types of colored malts may be appropriately used in combination, or one colored malt may be used.

The modification of the malt used in an aspect of the present invention is preferably greater than or equal to 80%. When the modification is less than 80%, the viscosity of the wort increases or the turbidity thereof increases, and the production efficiency such as wort filterability or beer filterability deteriorates. Thus, it is preferable to use malt with modification of greater than or equal to 80%. In Examples and Comparative Examples described below, malt having a modification greater than or equal to 80% was used. The modification can be measured by the method described in 3.1.3.8 Modification and Homogeneity (Calcofluor Carlsberg Method-EBC) in MEBAK Raw Materials Barley Adjuncts Malt Hops And Hop Products Published by the Chairman Dr. Fritz Jacob Self-published by MEBAK 85350 Freising-Weihenstephan, Germany 2011.

Note that in the beer-taste beverage according to an aspect of the present invention, the malt to be used is preferably selected as appropriate in accordance with the desired chromaticity of the beer-taste beverage, and the malt to be selected may be used alone or in combination of two or more kinds thereof.

In addition to or instead of malt, a grain other than malt may be used.

Examples of such a grain include barley and the like that do not fall under malt (such as barley, wheat, rye, common wild oats, oats, and adlay), rice (such as white rice and brown rice), corn, kaoliang, potato, legumes (such as soybeans and peas), buckwheat, sorghum, foxtail millet, Japanese millet, starch resulting therefrom, and extracts thereof.

Note that in a case of suppressing the malt proportion or not using malt, it is preferable to increase amounts of raw materials (carbon source and nitrogen source) other than malt, which can be utilized by yeast. Examples of the carbon source of the raw material that can be utilized by yeast include monosaccharides, disaccharides, trisaccharides, and sugar solutions thereof, and examples of the nitrogen source include yeast extract, amino acid-containing materials (such as soybean protein), soybean, yeast extract, pea, wheat malt, ungerminated grains, and decomposition products thereof.

Note that the beer-taste beverage according to an aspect of the present invention may be a beverage containing substantially no soybean peptide having a weight average molecular weight less than 10000 as a raw material, or may be a beverage having no soybean peptide described above.

The “beverage containing substantially no soybean peptide” means a beverage in which the soybean peptide is used in an amount less than 5.0 mass %, less than 3.0 mass %, less than 2.0 mass %, less than 1.0 mass %, less than 0.10 mass %, less than 0.01 mass %, less than 0.001 mass %, or less than 0.0001 mass %, with respect to the total amount (100 mass %) of raw materials excluding water of the beverage.

The fruit, pericarp, bark, leaf, flower, stem, root, and seed of a plant other than plants of the Gramineae family such as barley, which can be used as a raw material, can be appropriately selected.

Specific examples of the plant other than plants of the Gramineae family include citrus fruits, soft fruits, herbs, and spices. Examples of the citrus fruits include an orange, Citrus junos, a lemon, a lime, a mandarin orange, a grapefruit, Citrus Iyo Group, Citrus japonica, Citrus sphaerocarpa, Citrus limetta ‘Daidai’, Citrus depressa, and Citrus sudachi.

Examples of the soft fruits include a peach, a grape, a banana, an apple, a grape, a pineapple, a strawberry, a pear, a muscat, and a blackcurrant. Examples of the herbs and the spices include coriander, pepper, fennel, Sichuan pepper, zanthoxyli fructus, cardamom, caraway, nutmeg, mace, juniper berry, allspice, vanilla, elderberry, grains of paradise, anise, and star anise.

These may be used as they are, may be used after being crushed, may be used in the form of an extract derived by extraction with an extraction solvent such as water or ethanol, or may be used after being squeezed (fruit juice or the like). One of these herbs and spices may be used alone, or two or more thereof may be used in combination.

The above can be used as appropriate in accordance with the gusto of consumers, but in order to enjoy a clear and refreshing taste like beer, it is preferable that the above citrus fruits, soft fruits, herbs, and spices be not used at all or used in a minimum amount as raw materials. In particular, a blackcurrant gives an inappropriate milky aroma in beer, and thus a blackcurrant or blackcurrant juice is preferably not used at all or used in a minimum amount. 1.1.2 Hops

In a case of using hops in an aspect of the present invention, examples of the form of the hops include pellet hops, powdered hops, and hop extract. In addition, the hops used may be a processed hop product, such as isomerized hops or reduced hops.

In the case of using hops in an aspect of the present invention, the amount of hops to be added is appropriately adjusted but is preferably from 0.0001 to 1 mass % based on the total amount (100 mass %) of the raw materials for the beverage.

In addition, a beer-taste beverage made using hops as a raw material is a beverage containing iso-α-acid, which is a component derived from hops. The content of iso-α-acid in the beer-taste beverage made using hops may be greater than 0.1 mass ppm or greater than 1.0 mass ppm based on the total amount (100 mass %) of the beer-taste beverage.

On the other hand, the content of iso-α-acid in a beer-taste beverage made without using hops may be less than or equal to 0.1 mass ppm based on the total amount (100 mass %) of the beer-taste beverage.

In the present specification, the content of iso-α-acid means a value measured by the high-performance liquid chromatography (HPLC) analysis method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

### 1.1.3 Preservative

The beer-taste beverage according to an aspect of the present invention may be a beverage having a preservative.

Examples of the preservative used in an embodiment of the present invention include benzoic acid; benzoate salts, such as sodium benzoate; benzoate esters, such as propyl parahydroxybenzoate and butyl parahydroxybenzoate; and dimethyl dicarbonate. In addition, for the preservative, a commercially available preparation, such as Kyohryoku Sanpurezah (Powerful Sanplezer) (a mixture of sodium benzoate and butyl benzoate, available from San-Ei Gen F.F.I., Inc.) may be used.

One of these preservatives may be used alone, or two or more of these preservatives may be used in combination.

In a case of blending a preservative in the beer-taste beverage according to an aspect of the present invention, the content of the preservative is preferably 5 to 1200 mass ppm, more preferably 10 to 1100 mass ppm, even more preferably 15 to 1000 mass ppm, and still even more preferably 20 to 900 mass ppm.

### 1.1.4 Sweetener

The beer-taste beverage according to an aspect of the present invention may be a beverage in which the content of the saccharides (A) is adjusted to the above-described range and a sweetener is further blended.

Examples of the sweetener used in an aspect of the present invention include saccharified liquid in which starch derived from grain has been degraded with an acid, an enzyme, or the like; saccharides such as commercially available starch syrup; sucrose; tri- or higher saccharides; isomerized sugar; sugar alcohols; natural sweeteners, such as stevia; and artificial sweeteners.

One of these sweeteners may be used alone, or two or more of these sweeteners may be used in combination.

These saccharides may be in the form of a liquid, such as a solution, or a solid, such as a powder.

In addition, there are no particular limitations on the type of raw material grain for starch, the method of purifying starch, and the conditions for treatment, such as hydrolysis with an enzyme or an acid. For example, a saccharide may be used with the proportion of maltose increased by appropriately setting conditions for hydrolysis with an enzyme or an acid. In addition, sucrose, fructose, glucose, maltose, trehalose, maltotriose, maltotetraose, isomaltose, isomaltotriose, isomaltotetraose, and solutions thereof (sugar solutions) can also be used.

In addition, examples of the artificial sweetener include aspartame, acesulfame potassium (acesulfame K), sucralose, and neotame,

### 1.1.5 Water-Soluble Dietary Fiber

The beer-taste beverage of an aspect of the present invention may be a beverage in which water-soluble dietary fiber is blended, or may be a beverage in which no water-soluble dietary fiber is blended (added).

Examples of the water-soluble dietary fiber include indigestible dextrin, polydextrose, guar gum degradation products, pectin, glucomannan, alginic acid, laminarin, fucoidin, and carrageenan. From the viewpoint of versatility, such as stability and safety, indigestible dextrin or polydextrose is preferred.

Note that the beer-taste beverage according to an aspect of the present invention may be a beverage in which no indigestible dextrin is blended (added) as a raw material.

In the beer-taste beverage according to an aspect of the present invention, the content of the water-soluble dietary fiber may be greater than or equal to 0.1 mass %, greater than or equal to 0.3 mass %, greater than or equal to 0.5 mass %, greater than or equal to 0.7 mass %, greater than or equal to 1.0 mass %, greater than or equal to 1.5 mass %, greater than or equal to 2.0 mass %, greater than or equal to 2.5 mass %, or greater than or equal to 3.0 mass %, and less than or equal to 5.0%, less than or equal to 4.5%, less than or equal to 4.0%, less than or equal to 3.5%, less than or equal to 3.0%, less than or equal to 2.5%, less than or equal to 2.0%, less than 1.5%, less than 1.0%, less than 0.75%, less than 0.60%, less than 0.50%, less than 0.40%, less than 0.30%, less than 0.20%, less than 0.10%, or less than 0.01%, based on the total amount (100 mass %) of the beer-taste beverage.

Note that the content of the water-soluble dietary fiber may be adjusted to fall within the above range by adding a commercially available product, or may be adjusted in the production process in such a manner that the content of the dietary fiber derived from a raw material such as malt falls within the above range. In a case of adding a commercially available product, when the content of the water-soluble dietary fiber is within the above-described range, powderiness unsuitable for a beer-taste beverage can be suppressed. In a case of adjusting the content of the dietary fiber in the production process, when the content of the water-soluble dietary fiber is set within the above range, for example, the filterability in wort filtration or beer filtration can be improved to increase the production efficiency.

In the case of adjusting the content of water-soluble dietary fiber in the production process, the content of water-soluble dietary fiber in the beer-taste beverage according to an aspect of the present invention can be adjusted by adjusting the addition of dilution water or carbonated water, the type of raw materials (such as barley, malt, corn, and sugar solution), the amount of raw material, the type of enzyme, the amount of enzyme added, the timing of enzyme addition (such as during the saccharification step, before addition of yeast, after addition of yeast, and during aging), the set temperature, pH, and holding time in each temperature region in preparing the saccharified liquid, and the like.

### 1.1.6 Bittering Agent and Bitterness-Imparting Agent

The beer-taste beverage according to an aspect of the present invention may be a beverage further containing one or more selected from the group consisting of a bittering agent and a bitterness-imparting agent.

In the beer-taste beverage according to an aspect of the present invention, the bitterness is preferably imparted by hops, and a bittering agent or a bitterness-imparting agent indicated below may be used together with hops. Alternatively, the bittering agent or bitterness-imparting agent indicated below may be used instead of hops without using hops.

The bittering agent or bitterness-imparting agent is not particularly limited, and a substance used as a bitterness-imparting agent in ordinary beer and low-malt beer can be used. Examples thereof include rosemary, litchi, caraway, juniper berry, sage, Ganoderma sichuanense, bay laurel, quassin, caffeine, absinthin, naringin, Phellodendron amurense, citrus extract, bitter wood extract, coffee extract, tea extract, bitter gourd extract, lotus embryo extract, Aloe arborescens extract, rosemary extract, litchi extract, laurel extract, sage extract, caraway extract, Artemisia absinthium, absinthin, and alginic acid.

One of these bittering agents and bitterness-imparting agents may be used alone, or two or more thereof may be used in combination.

### 1.1.7 Antioxidant

The beer-taste beverage according to an aspect of the present invention may be a beverage further containing an antioxidant.

The antioxidant is not particularly limited, and a substance used as an antioxidant in ordinary beer and low-malt beer can be used, and examples include ascorbic acid, erythorbic acid, and catechin.

One of these antioxidants may be used alone, or two or more thereof may be used in combination.

### 1.1.8 Flavoring

The beer-taste beverage according to an aspect of the present invention may be a beverage further containing a flavoring.

The flavoring is not particularly limited, and a general beer flavoring can be used. The beer flavoring is used for imparting a beer-like flavor.

Examples of the flavor component contained in the beer flavoring include ester and higher alcohol. Specific examples thereof include isoamyl acetate, ethyl acetate, n-propanol, isobutanol, acetaldehyde, ethyl caproate, ethyl caprylate, isoamyl propionate, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methyl butyrate, ethyl n-butyrate, myrcene, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentan-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

One of these flavorings may be used alone, or two or more of these flavorings may be used in combination.

Note that in the beer-taste beverage according to an aspect of the present invention, the content of acetaldehyde may be greater than or equal to 1.0 mg/L, greater than or equal to 5.0 mg/L, greater than or equal to 7.0 mg/L, greater than or equal to 10.0 mg/L, greater than or equal to 15.0 mg/L, greater than or equal to 20.0 mg/L, greater than or equal to 25.0 mg/L, greater than or equal to 30.0 mg/L, greater than or equal to 35.0 mg/L, greater than or equal to 40.0 mg/L, greater than or equal to 45.0 mg/L, greater than 50.0 mg/L, or greater than or equal to 52.0 mg/L, and may be less than or equal to 70.0 mg/L, less than or equal to 60.0 mg/L, less than or equal to 50.0 mg/L, less than or equal to 40.0 mg/L, less than or equal to 30.0 mg/L, less than or equal to 20.0 mg/L, less than or equal to 15.0 mg/L, less than or equal to 10.0 mg/L, less than or equal to 7.0 mg/L, less than or equal to 5.0 mg/L, less than or equal to 3.0 mg/L, less than 1.0 mg/L, less than or equal to 0.9 mg/L, less than or equal to 0.8 mg/L, less than or equal to 0.7 mg/L, less than or equal to 0.6 mg/L, less than or equal to 0.5 mg/L, less than or equal to 0.4 mg/L, less than or equal to 0.3 mg/L, less than or equal to 0.2 mg/L, or less than or equal to 0.1 mg/L.

Note that in the beer-taste beverage according to an aspect of the present invention, the content of diacetyl may be greater than or equal to 1.0 mass ppb, greater than or equal to 5.0 mass ppb, greater than or equal to 7.0 mass ppb, greater than or equal to 10.0 mass ppb, greater than or equal to 15.0 mass ppb, greater than or equal to 20.0 mass ppb, greater than or equal to 25.0 mass ppb, greater than 30.0 mass ppb, or greater than or equal to 32.0 mass ppb, or may be less than or equal to 50.0 mass ppb, less than or equal to 40.0 mass ppb, less than or equal to 30.0 mass ppb, less than or equal to 20.0 mass ppb, less than or equal to 15.0 mass ppb, less than or equal to 10.0 mass ppb, less than or equal to 8.0 mass ppb, less than or equal to 6.0 mass ppb, less than 4.0 mass ppb, less than or equal to 3.5 mass ppb, less than or equal to 3.0 mass ppb, less than or equal to 2.5 mass ppb, less than or equal to 2.0 mass ppb, less than or equal to 1.5 mass ppb, less than or equal to 1.0 mass ppb, less than or equal to 0.8 mass ppb, less than or equal to 0.6 mass ppb, less than or equal to 0.5 mass ppb, less than or equal to 0.3 mass ppb, or less than or equal to 0.1 mass ppb, based on the total amount (100 mass %) of the beer-taste beverage.

The content of the flavor component such as ester or higher alcohol can be adjusted by separately adding a flavoring containing these flavor components. However, when alcoholic fermentation is involved in the production process, the content may be adjusted by alcoholic fermentation without adding a flavoring or together with addition of a flavoring.

The content of the flavor component such as ester or higher alcohol in a case of involving alcoholic fermentation can be controlled by appropriately setting the addition of diluting water or carbonated water, the sugar composition and amino acid composition of the pre-fermentation liquid before addition of yeast, sugar concentration, amino acid concentration, original extract concentration in the pre-fermentation liquid, yeast species, fermentation conditions (such as oxygen concentration, aeration conditions, yeast species, amount of yeast added, the number of yeast grown, yeast removal timing, fermentation temperature, fermentation time, pressure setting, and carbon dioxide concentration), cooling timing, and the like.

### 1.1.9 Acidulant

The beer-taste beverage according to an aspect of the present invention may be a beverage further containing an acidulant.

The acidulant is not particularly limited as long as it is a substance with a sour taste, and examples include tartaric acid, phosphoric acid, citric acid, gluconic acid, lactic acid, malic acid, phytic acid, acetic acid, succinic acid, glucono-delta-lactone, and salts thereof.

Among these, the acidulant is preferably at least one selected from the group consisting of tartaric acid, phosphoric acid, citric acid, gluconic acid, lactic acid, malic acid, phytic acid, acetic acid, succinic acid, and salts thereof, more preferably at least one selected from the group consisting of tartaric acid, phosphoric acid, citric acid, lactic acid, acetic acid, and salts thereof, and even more preferably at least one selected from the group consisting of tartaric acid, phosphoric acid, and lactic acid.

One of these acidulants may be used alone, or two or more of these acidulants may be used in combination.

### 1.1.10 Salt

The beer-taste beverage according to an aspect of the present invention may be a beverage further containing a salt.

Examples of the salt include sodium chloride, acid potassium phosphate, acid calcium phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in combination.

1.2 Carbonic acid gas

As the carbonic acid gas contained in the beer-taste beverage according to an aspect of the present invention, carbonic acid gas contained in a raw material may be used, or carbonic acid gas may be dissolved by mixing with carbonated water, addition of carbonic acid gas, or the like. Note that the carbonic acid gas generated in the fermentation step of the beer-taste beverage can be used as it is, but the amount of the carbonic acid gas may be adjusted by appropriately adding carbonated water.

The carbonic acid gas concentration of the beer-taste beverage according to an aspect of the present invention is preferably greater than or equal to 0.30 (w/w) %, more preferably greater than or equal to 0.35 (w/w) %, more preferably greater than or equal to 0.40 (w/w) %, even more preferably greater than or equal to 0.42 (w/w) %, even more preferably greater than or equal to 0.45 (w/w) %, still even more preferably greater than or equal to 0.47 (w/w) %, and particularly preferably greater than or equal to 0.50 (w/w) %, and preferably less than or equal to 0.80 (w/w) %, more preferably less than or equal to 0.70 (w/w) %, even more preferably less than or equal to 0.60 (w/w) %, still even more preferably less than or equal to 0.57 (w/w) %, and particularly preferably less than or equal to 0.55 (w/w) %.

Note that in the present specification, the carbonic acid gas concentration can be measured by immersing a container containing a target beverage in a water bath at 20° C. for 30 minutes or longer with occasional shaking of the container to adjust the beverage to 20° C. and then using a gas volume measuring device (e.g., such as GVA-500 (available from Kyoto Electronics Manufacturing Co., Ltd.)).

In a case where the beer-taste beverage according to an aspect of the present invention is a packaged beverage, the carbonic acid gas pressure of the packaged beverage only needs to be appropriately adjusted such that the carbonic acid gas concentration is in the ranges described above, and may be less than or equal to 5.0 kg/cm², less than or equal to 4.5 kg/cm², or less than or equal to 4.0 kg/cm², and may be greater than or equal to 0.20 kg/cm², greater than or equal to 0.50 kg/cm², or greater than or equal to 1.0 kg/cm². Any of these upper and lower limits may be combined; for example, the carbonic acid gas pressure of the beverage may be greater than or equal to 0.20 kg/cm² and less than or equal to 5.0 kg/cm², greater than or equal to 0.50 kg/cm² and less than or equal to 4.5 kg/cm², or greater than or equal to 1.0 kg/cm² and less than or equal to 4.0 kg/cm².

In the present specification, the gas pressure refers to the gas pressure in the container except in special cases.

The pressure can be measured by a method well-known to those skilled in the art, for example, using a method in which a sample adjusted to 20° C. is fixed to a gas internal pressure meter, the stopcock of the gas internal pressure meter is opened once to release the gas, the stopcock is closed again, the gas internal pressure meter is shaken, and a value when the pointer reaches a certain position is read; or using a commercially available gas pressure measuring device.

### 1.3 Additional Additive

To the beer-taste beverage according to an aspect of the present invention, an additive of various types may be added as necessary to the extent that the effects of the present invention are not hindered.

Examples of such an additive include colorants; foam-forming agents; fermentation promoters; yeast extract; protein-based substances, such as peptide-containing substances; and seasonings, such as amino acids.

The colorant is used to impart a beer-like color to the beverage, and a caramel dye and/or the like can be used. The foam-forming agent is used to form beer-like foam or to keep the foam of the beverage, and a plant-extracted saponin-based substance, such as soybean saponin and/or quillaja saponin; a plant protein, such as corn and/or soybean; a peptide-containing substance, such as a collagen peptide; a yeast extract; an emulsifier (sucrose fatty acid ester, glycerin fatty acid ester, lecithin, and/or lysolecithin); and/or the like can be appropriately used.

The fermentation promoter is used to promote fermentation by yeast. For example, a yeast extract; a bran component of rice, wheat, or the like; a vitamin; a mineral agent; and/or the like can be used alone or in combination.

### 1.4 Packaged Beverage

The beer-taste beverage according to an aspect of the present invention may be a packaged beverage packaged in a container. For the packaged beverage, a container of any form and material may be used, and examples of the container include a bottle, a can, a barrel, or a PET bottle. In particular, from the viewpoint of easy portability, the container is preferably a can, a bottle, or a PET bottle.

2 Method for producing beer-taste beverage

A method for producing a beer-taste beverage according to an aspect of the present invention includes the following steps (I) to (III):
(I): adjusting an alcohol content to less than or equal to 5.0 (v/v) %;
(II): using, as a saccharide, one or more saccharides (A) selected from the group consisting of glucose, sucrose, maltose, isomaltose, maltotriose, and isomaltotriose, and adjusting a total content of the one or more saccharides (A) to greater than or equal to 0.07 (w/v) %; and
(III): adjusting a content of linalool to less than or equal to 140 μg/L.
Note that the order of steps (I) to (III) is not particularly limited.

The method for producing a beer-taste beverage according to an aspect of the present invention is not particularly limited, and may be a method for producing a beer-taste beverage through a fermentation step or may be a method for producing a beer-taste beverage without a fermentation step.

Hereinafter, a method for producing a fermented beer-taste beverage through a fermenting step and a method for producing a non-fermented beer-taste beverage without a fermenting step will be described.

### 2.1 Method for Producing Fermented Beer-Taste Beverage

As the method for producing a fermented beer-taste beverage according to an aspect of the present invention, a method through a fermentation step using yeast is exemplified and includes, for example, the following steps (1) to (2):
(1) performing at least one treatment of the group consisting of saccharification treatment, boiling treatment, and solid content removal treatment, using various raw materials to produce a pre-fermentation liquid; and
(2) adding yeast to the pre-fermentation liquid to perform alcoholic fermentation.

In addition, in the method for producing a fermented beer-taste beverage according to an aspect of the present invention, the above steps (I) to (III) and adjustment of the contents of the saccharides (A1) and the saccharides (A2), the content of T-VDK, the total polyphenol amount, the bitterness value, and the pH can be performed at any one or more timings of the following (i) to (iii). In a case where the steps (I) to (III) and the adjustment described above can be performed at the same time by performing the steps (1) and (2), it is not necessary to separately perform these steps.
(i): Simultaneously with at least one of step (1) and step (2)
(ii): Between step (1) and step (2)
(iii): After step (2)

Hereinafter, each step of the method for producing a fermented beer-taste beverage according to an aspect of the present invention will be described.

### 2.1.1 Step (1)

Step (1) is a step of performing at least one treatment of the group consisting of saccharification treatment, boiling treatment, and solid content removal treatment, using various raw materials to produce a pre-fermentation liquid.

For example, in a case of using malt as a raw material, various raw materials including water and malt are fed in a preparation kettle or a preparation tank, and an enzyme such as amylase is added as necessary. Examples of various raw materials that may be added besides malt include hops, a preservative, a sweetener, a water-soluble dietary fiber, a bittering agent or bitterness-imparting agent, an antioxidant, a flavoring, an acidulant, a pigment, and/or the like. These raw materials may be added before performing the saccharification treatment, during the saccharification treatment, or after completion of the saccharification treatment. In addition, these raw materials may be added after the fermentation in the next step.

A mixture of the various raw materials is heated to saccharify the starch of the raw materials to perform saccharification treatment.

The temperature and time of the saccharification treatment are preferably appropriately adjusted in view of the type of malt used, the malt proportion, raw materials besides water and malt, the type and amount of the enzyme used, the original wort extract concentration of the finally resulting beverage, and the like. In an aspect of the present invention, from the viewpoint of adjusting the sugar concentration and turbidity of the beer-taste beverage to the above ranges, the temperature of the saccharification treatment is preferably from 55 to 75° C., and the time of the saccharification treatment is preferably from 30 to 240 minutes.

The saccharified liquid is preferably subjected to boiling treatment.

When this boiling treatment is performed, hops, a bittering agent, and the like are preferably added in the case of using them as raw materials. Hops, a bittering agent, and/or the like may be added between the start of boiling the saccharified liquid and a time point before the completion of the boiling.

After completion of the boiling treatment, it is preferable that the liquid be transferred to a whirlpool and cooled to 0 to 23° C. to form a cooled liquid, and then a treatment for removing a solid content such as coagulated protein be performed. With this treatment, the original wort extract concentration can be adjusted to the above range. In this way, a pre-fermentation liquid is produced.

Note that in the present step, filtration through a filter having a predetermined pore diameter (for example, a pore diameter less than 30 μm) may be performed to perform the removal treatment of the solid content.

Instead of the saccharified liquid, a pre-fermentation liquid may be prepared by adding hops, a bittering agent, and/or the like to a mixture in which warm water has been added to a malt extract, and boiling the mixture.

In addition, in the case of not using malt, a pre-fermentation liquid may be prepared by mixing, as the raw materials, a liquid sugar containing a carbon source; a nitrogen source as an amino acid-containing raw material other than barley and the like or malt; hops; a dietary fiber; a preservative; a sweetener; an antioxidant; a bitterness-imparting agent; a flavoring; an acidulant; a pigment; and/or the like together with warm water to prepare a liquid sugar solution, and boiling the liquid sugar solution.

In the case of using hops, it may be added before the boiling treatment or may be added between the start of boiling the liquid sugar solution and before the completion of the boiling.

### 2.1.2 Step (2)

Step (2) is a step of adding yeast to the pre-fermentation liquid formed in step (1) to perform fermentation.

The yeast used in this step can be appropriately selected in view of the type of the fermented beverage to be produced, the target flavor, the fermentation conditions, and the like, and top-fermenting yeast may be used, or bottom-fermenting yeast may be used.

The yeast in the form of a yeast suspension as is may be added to the raw material liquid, or a slurry produced by concentrating the yeast by centrifugation or sedimentation may be added to the stock solution. Alternatively, a material from which the supernatant has been completely removed after the centrifugation may be added. The amount of yeast added to the stock solution can be appropriately set and is, for example, approximately from 5.0×10⁶ cells/mL to 1.0×10⁹ cells/mL.

The fermentation conditions in performing fermentation can be set as appropriate, but the fermentation temperature is preferably 5 to 25° C. from the viewpoint of adjusting the sugar concentration and the alcohol content of the beer-taste beverage to the ranges described above. The sugar concentration and the alcohol content of the beer-taste beverage can be adjusted by appropriately setting the type, amount, and timing of addition of the polysaccharide-degrading enzyme such as transglucosidase. They can be also adjusted by changing the temperature (temperature increase or temperature decrease) or pressure of the fermented liquid during the fermentation step as necessary.

After the fermentation, filtration treatment for removing yeast in the beer-taste beverage may be performed, or filtration treatment does not need to be performed. As necessary, water and/or the above-described various additives may be added.

### 2.1.4 Steps (3) and (4)

In an aspect of the present invention, in a case of producing a non-alcohol fermented beer-taste beverage, the beverage may be produced through a step of non-alcoholic fermentation using yeast that does not produce alcohol. In this case, yeast that does not produce alcohol only needs to be used in the step (2) above.

In a case of producing a non-alcohol fermented beer-taste beverage using yeast that produces alcohol, it is preferable to further perform steps (3) and (4) together with the steps (1) and (2):
(3): removing an alcohol content from the fermented liquid after the step (2); and
(4): adjusting an amount of carbonic acid gas after the step (3).

In the step (3), as a method for removing the alcohol content produced by the fermentation step of the step (2), a method for removing the alcohol content by heat treatment is preferable. As conditions for the heat treatment, conditions similar to those in a general method for producing a non-alcohol beer-taste beverage can be applied.

After the step (3), the alcohol content is removed from the solution and carbonic acid gas is also removed. Thus, it is preferable to adjust the amount of carbonic acid gas by the step (4).

As a method for adjusting the amount of carbonic acid gas, carbonic acid gas may be added by mixing the solution after the step (3) with carbonated water, or carbonic acid gas may be directly added to the solution after the step (3).

The beer-taste beverage thus produced according to an aspect of the present invention is filled in a predetermined container and distributed to the market as a product.

The method of packaging the beer-taste beverage is not particularly limited, and a packaging method known to those skilled in the art can be used. Through the packaging step, the beer-taste beverage according to the present invention is filled and sealed in a container. In the packaging step, a container of any form and material may be used, and examples of the container include containers described in “1.4 Packaged beverage”.

### 2.2 Method for Producing Non-Fermented Beer-Taste Beverage

A method for producing a non-fermented beer-taste beverage according to an aspect of the present invention only needs to be a method without the fermentation step, and includes, for example, the following steps (a) to (c):
(a): performing at least one treatment of saccharification treatment, boiling treatment, or solid content removal treatment on a raw material to produce a pre-beverage liquid; and
(b): cooling the pre-beverage liquid produced in the step (a) and adding carbonic acid gas thereto.

The step (a) is the same as the step of producing a pre-fermentation liquid of the step (1) in the “method for producing a fermented beer-taste beverage” described above.

As a method of adding carbonic acid gas in the step (b), carbonic acid gas may be added by mixing the cooled pre-beverage liquid formed by cooling the pre-beverage liquid produced in the step (a) with carbonated water, or carbonic acid gas may be directly added to the cooled beverage stock solution. When carbonic acid gas is added at the same timing as the step (b), additives such as a preservative, a sweetener, a flavoring, an acidulant, and a pigment may be added as necessary.

In a case where the non-fermented beer-taste beverage is a non-fermented alcohol-containing beer-taste beverage, the method includes the following step (c):
(c): blending an alcohol component at least after the step (a).

The step (c) only needs to be performed at least after the step (a), and can be performed, for example, at any one or more timings of the following (I) to (III):
(I): between step (a) and step (b);
(II): simultaneously with step (b); and
(III): after step (b).

Among them, the step (c) is preferably performed after the pre-beverage liquid produced in the step (a) is cooled to prepare a cooled beverage stock solution and before carbonic acid gas is added.

As the alcohol component to be blended in the step (c), spirits (liquor) derived from the above-described grains is preferable.

In the method for producing a non-fermented beer-taste beverage according to the present invention, the steps (I) to (III) above, and adjustment of contents of the saccharides (A1) and the saccharides (A2), the content of T-VDK, the total polyphenol amount, the bitterness value, and the pH can be performed at one or more timings of (i) to (v) below. In a case where the steps (I) to (III) and the above-described adjustment can be simultaneously performed by performing the steps (a) to (c), it is not necessary to separately perform these steps.
(i): Simultaneously with at least one of the group consisting of step (a), step (b), and step (c)
(ii): Between step (a) and step (b)
(iii): Between step (a) and step (c)
(iv): After step (b) or between step (b) and step (c)
(v): After step (c)

The non-fermented beer-taste beverage thus produced is filled in a predetermined container and distributed to the market as a product.

The method of packaging the non-fermented beer-taste beverage is not particularly limited, and a packaging method known to those skilled in the art can be used. Through the packaging step, the non-fermented beer-taste beverage is filled and sealed in a container. In the packaging step, a container of any form and material may be used, and examples of the container are as described above.

### 3. Method for Improving Flavor of Beer-Taste Beverage

The method for improving a flavor of a beer-taste beverage according to an aspect of the present invention includes at least the following operations (I) to (III):
operation (I): an operation of adjusting an alcohol content to less than or equal to 5.0 (v/v) %;
operation (II): an operation of using, as a saccharide, one or more saccharides (A) selected from the group consisting of glucose, sucrose, maltose, isomaltose, maltotriose, and isomaltotriose, and adjusting a total content of the one or more saccharides (A) to greater than or equal to 0.07 (w/v) %; and
operation (III): an operation of adjusting a content of linalool to less than or equal to 140 μg/L.

The operations (I) to (III) correspond to the steps (I) to (III) in the method for producing a beer-taste beverage described above, respectively.

Suitable ranges of the alcohol content, the content of the saccharides (A), and the content of linalool, as well as various properties, various components, the contents thereof, and the like of the beer-taste beverage are as described in “1. Beer-taste beverage” described above.

### EXAMPLES

Hereinafter, the present invention will be described in more detail by examples, but the present invention is not limited by these examples.

### Examples 1 to 23 and Comparative Examples 1 to 14

### Preparation of Beverage

Crushed barley malt was used as a raw material, and in Examples 5 to 7, 9, 13, and 14, sucrose was further used as a raw material. The raw materials were fed in a preparation tank containing 40 L of warm water kept at a temperature in a range from 40 to 55° C., then the temperature was raised to 78° C. while the temperature was repeatedly raised and kept in a stepwise manner, then malt dregs were removed by filtration, and a saccharified liquid was produced. Next, hops were further added to the saccharified liquid, boiling was performed, and solid-liquid separation treatment was performed to produce clear wort. Then, brewer's yeast (bottom-fermenting yeast) was added to the pre-fermentation liquid formed by cooling the wort, and the fermentation temperature and the fermentation time were adjusted to perform alcoholic fermentation in such a manner to achieve a predetermined alcohol content. Then, the yeast was removed by filtration to produce a beverage, which would be categorized as beer in the Liquor Tax Law.

Note that in each of the Examples and Comparative Examples, the alcohol content, the content of T-VDK, the total polyphenol amount, and the bitterness value were adjusted to the values shown in Tables 1 to 3 bp appropriately setting the set temperature and the holding time of each temperature region, the amount of hop added, the fermentation temperature, the fermentation time, and the like when preparing the saccharified liquid. The contents of the saccharides (A), (A1), and (A2), and the content of linalool were adjusted to the values shown in Tables 1 to 3 by adding saccharides corresponding to the saccharides (A), (A1), and (A2), and linalool as necessary in addition to setting the conditions described above.

Note that in each of Examples and Comparative Examples, the beverages prepared as described above had an apparent fermentation degree greater than or equal to 60% and less than 90% and a sugar content greater than 0.5 g/100 mL.

### Sensory Evaluation

Five panelists who had been regularly trained evaluated the beverages produced in examples and comparative examples cooled to approximately 4° C. for the “presence or absence of drinking sensation suitable for a beer-taste beverage”, “presence or absence of crispness suitable for a beer-taste beverage”, “presence or absence of astringency unsuitable for a beer-taste beverage”, “presence or absence of unripe odor unsuitable for a beer-taste beverage”, and “presence or absence of cosmetic aroma unsuitable for a beer-taste beverage” of each beverage for testing by a score in a range from 1.0 (minimum value) to 3.0 (maximum value) in increments of 0.1 based on the score criteria described below, and average values of the scores of the five panelists were calculated. The results are shown in Tables 1 to 3.

Note that in the evaluation, samples that meet the following criteria “3.0”, “2.5”, “2.0”, “1.5”, and “1.0” were prepared in advance to standardize the criteria among the panelists. In addition, in the sensory evaluation of all Tables 1 and 2, for the same beverage, no difference in a score value greater than or equal to 1.5 was observed among the panelists.

Score criteria for presence or absence suitable for beer-taste beverage
“3.0”: The drinking sensation suitable for a beer-taste beverage is very strongly perceived.
“2.5”: The drinking sensation suitable for a beer-taste beverage is strongly perceived.
“2.0”: The drinking sensation suitable for a beer-taste beverage is sufficiently perceived.
“1.5”: The drinking sensation suitable for a beer-taste beverage is hardly perceived.
“1.0”: The drinking sensation suitable for a beer-taste beverage is not perceived at all.

Score criteria for presence or absence of crispness suitable for beer-taste beverage
“3.0”: Crispness suitable for a beer-taste beverage is very strongly perceived.
“2.5”: Crispness suitable for a beer-taste beverage is strongly perceived.
“2.0”: Crispness suitable for a beer-taste beverage is sufficiently perceived.
“1.5”: Crispness suitable for a beer-taste beverage is hardly perceived.
“1.0”: Crispness suitable for a beer-taste beverage is not perceived at all.

Score criteria for presence or absence of astringency unsuitable for beer-taste beverage
“3.0”: Unsuitable astringency is not perceived at all.
“2.5”: Unsuitable astringency is hardly perceived.
“2.0”: Unsuitable astringency is not generally perceived.
“1.5”: Unsuitable astringency is strongly perceived.
“1.0”; Unsuitable astringency is very strongly perceived.

Score criteria for presence or absence of unripe odor unsuitable for beer-taste beverage
“3.0”; Unsuitable unripe odor is not perceived at all.
“2.5”: Unsuitable unripe odor is hardly perceived.
“2.0”: Unsuitable unripe odor is not generally perceived.
“1.5”: Unsuitable unripe odor is strongly perceived.
“1.0”: Unsuitable unripe odor is very strongly perceived.

Score criteria of presence or absence of cosmetic aroma unsuitable for beer-taste beverage
“3.0”: Unsuitable cosmetic aroma is not perceived at all.
“2.5”: Unsuitable cosmetic aroma is hardly perceived.
“2.0”: Unsuitable cosmetic aroma is not generally perceived.
“1.5”: Unsuitable cosmetic aroma is strongly perceived.
“1.0”: Unsuitable cosmetic aroma is very strongly perceived.

Based on the above five evaluation items, overall evaluation was made according to the following criteria.

Overall evaluation
“A”: All of the average scores of the five tested sensory evaluation items are greater than or equal to 2.5.
“B”: All of the average scores of the five tested sensory evaluation items are greater than or equal to 2.0, and at least one of the average scores of the five sensory evaluation items is greater than or equal to 2.0 and less than 2.5.
“C”: At least one of the average scores of the five tested sensory evaluation items are less than 2.0.

TABLE 1

| | | | | Compar- | | | | Compar- |
|---|---|---|---|---|---|---|---|---|
| | | | | ative | | | | ative |
| | | | Exam- | Exam- | Exam- | Exam- | Exam- | Exam- |
| | | | ple 1 | ple 1 | ple 2 | ple 3 | ple 4 | ple 2 |
| Property | Alcohol content | (v/v)% | 3.0 | 3.0 | 3.0 | 3.0 | 3.0 | 3.0 |
| of beer- | Total content | (w/v)% | 0.86 | 0.05 | 0.10 | 1.29 | 2.00 | 0.10 |
| taste | of saccharides | | | | | | | |
| beverage | (A) (*1) | | | | | | | |
| | Total content | (w/v)% | 0.69 | 0.04 | 0.08 | 1.03 | 1.60 | 0.08 |
| | of saccharides | | | | | | | |
| | (A1) (*2) | | | | | | | |
| | Total content | (w/v)% | 0.068 | 0.004 | 0.008 | 0.10 | 0.16 | 0.008 |
| | of saccharides | | | | | | | |
| | (A2) (*3) | | | | | | | |
| | Content of | μg/L | 8.5 | 8.5 | 1.0 | 100.0 | 100.0 | 0.0 |
| | linalool | | | | | | | |
| | Content of | mass ppm | 0.05 | 0.06 | 0.05 | 0.05 | 0.05 | 0.40 |
| | T-VDK | | | | | | | |
| | Total | mass ppm | 128 | 110 | 130 | 129 | 130 | 100 |
| | polyphenol | | | | | | | |
| | amount | | | | | | | |
| | Bitterness | BUs | 18.7 | 15.0 | 5.0 | 29.0 | 29.0 | 5.0 |
| | value | | | | | | | |
| | Malt | mass % | 100 | 100 | 100 | 100 | 100 | 100 |
| | proportion | | | | | | | |
| | Alcohol | (v/v)%/ | 3.49 | 60.00 | 30.00 | 2.33 | 1.50 | 30.00 |
| | content/ | (w/v)% | | | | | | |
| | saccharides | | | | | | | |
| | (A) | | | | | | | |
| | Bitterness | BUs/ | 21.74 | 300.00 | 50.00 | 22.48 | 14.50 | 50.00 |
| | value/ | (w/v)% | | | | | | |
| | saccharides | | | | | | | |
| | (A) | | | | | | | |
| | Linalool/ | μg/ | 9.88 | 170.00 | 10.00 | 77.52 | 50.00 | 0.00 |
| | saccharides | (w/v)% | | | | | | |
| | (A) | | | | | | | |

| | | | | | | | |
|---|---|---|---|---|---|---|---|
| Sensory | Presence or absence | 2.50 | 1.50 | 2.20 | 2.65 | 2.70 | 2.20 |
| evaluation | of drinking sensation | | | | | | |
| | suitable for beer- | | | | | | |
| | taste beverage | | | | | | |
| | Presence or absence | 2.50 | 2.70 | 2.70 | 2.55 | 2.50 | 2.70 |
| | of crispness suitable | | | | | | |
| | for beer-taste | | | | | | |
| | beverage | | | | | | |
| | Presence or absence | 2.50 | 2.50 | 2.50 | 2.50 | 2.50 | 2.50 |
| | of astringency | | | | | | |
| | unsuitable for | | | | | | |
| | beer-taste beverage | | | | | | |
| | Presence or absence | 2.50 | 2.95 | 2.55 | 2.80 | 2.80 | 1.50 |
| | of unripe odor | | | | | | |
| | unsuitable for | | | | | | |
| | beer-taste beverage | | | | | | |
| | Presence or absence | 2.50 | 2.50 | 2.50 | 2.10 | 2.10 | 2.50 |
| | of cosmetic aroma | | | | | | |
| | unsuitable for | | | | | | |
| | beer-taste beverage | | | | | | |
| | Overall evaluation | A | C | B | B | B | C |

| | | | Compar- | Compar- | | | |
|---|---|---|---|---|---|---|---|
| | | | ative | ative | | | |
| | | | Exam- | Exam- | Exam- | Exam- | Exam- |
| | | | ple 3 | ple 4 | ple 5 | ple 6 | ple 7 |
| Property | Alcohol content | (v/v)% | 3.0 | 3.0 | 3.0 | 3.0 | 3.0 |
| of beer- | Total content | (w/v)% | 0.10 | 1.29 | 0.86 | 0.10 | 1.29 |
| taste | of saccharides | | | | | | |
| beverage | (A) (*1) | | | | | | |
| | Total content | (w/v)% | 0.08 | 1.03 | 0.69 | 0.08 | 1.03 |
| | of saccharides | | | | | | |
| | (A1) (*2) | | | | | | |
| | Total content | (w/v)% | 0.008 | 0.10 | 0.068 | 0.008 | 0.10 |
| | of saccharides | | | | | | |
| | (A2) (*3) | | | | | | |
| | Content of | μg/L | 0.0 | 150.0 | 8.5 | 1.0 | 100.0 |
| | linalool | | | | | | |
| | Content of | mass ppm | 0.05 | 0.05 | 0.05 | 0.05 | 0.05 |
| | T-VDK | | | | | | |
| | Total | mass ppm | 105 | 108 | 75 | 70 | 78 |
| | polyphenol | | | | | | |
| | amount | | | | | | |
| | Bitterness | BUs | 5.0 | 29.0 | 18.7 | 5.0 | 29.0 |
| | value | | | | | | |
| | Malt | mass % | 100 | 100 | 50 | 50 | 50 |
| | proportion | | | | | | |
| | Alcohol | (v/v)%/ | 30.00 | 2.33 | 3.49 | 30.00 | 2.33 |
| | content/ | (w/v)% | | | | | |
| | saccharides | | | | | | |
| | (A) | | | | | | |
| | Bitterness | BUs/ | 50.00 | 22.48 | 21.74 | 50.00 | 22.48 |
| | value/ | (w/v)% | | | | | |
| | saccharides | | | | | | |
| | (A) | | | | | | |
| | Linalool/ | μg/ | 0.00 | 116.28 | 9.88 | 10.00 | 77.52 |
| | saccharides | (w/v)% | | | | | |
| | (A) | | | | | | |

| | | | | | | |
|---|---|---|---|---|---|---|
| Sensory | Presence or absence | 2.20 | 2.65 | 2.50 | 2.20 | 2.65 |
| evaluation | of drinking sensation | | | | | |
| | suitable for beer- | | | | | |
| | taste beverage | | | | | |
| | Presence or absence | 2.70 | 2.55 | 2.50 | 2.70 | 2.55 |
| | of crispness suitable | | | | | |
| | for beer-taste | | | | | |
| | beverage | | | | | |
| | Presence or absence | 2.50 | 2.50 | 2.50 | 2.50 | 2.50 |
| | of astringency | | | | | |
| | unsuitable for | | | | | |
| | beer-taste beverage | | | | | |
| | Presence or absence | 1.70 | 2.90 | 2.50 | 2.55 | 2.80 |
| | of unripe odor | | | | | |
| | unsuitable for | | | | | |
| | beer-taste beverage | | | | | |
| | Presence or absence | 2.50 | 1.50 | 2.50 | 2.50 | 2.10 |
| | of cosmetic aroma | | | | | |
| | unsuitable for | | | | | |
| | beer-taste beverage | | | | | |
| | Overall evaluation | C | C | A | B | B |

(*1) Total content of glucose, sucrose, maltose, isomaltose, maltotriose, and isomaltotriose
(*2) Total content of maltose and maltotriose
(*3) Total content of isomaltose and isomaltotriose

TABLE 2

| | | | Exam- | Exam- | Exam- | Exam- | Exam- | Exam- |
|---|---|---|---|---|---|---|---|---|
| | | | ple 8 | ple 9 | ple 10 | ple 11 | ple 12 | ple 13 |
| Property | Alcohol content | (v/v)% | 3.7 | 3.7 | 3.7 | 3.7 | 3.7 | 3.7 |
| of beer- | Total content | (w/v)% | 1.00 | 0.86 | 0.10 | 1.29 | 2.00 | 0.10 |
| taste | of saccharides | | | | | | | |
| beverage | (A) (*1) | | | | | | | |
| | Total content | (w/v)% | 0.80 | 0.69 | 0.08 | 1.03 | 1.60 | 0.08 |
| | of saccharides | | | | | | | |
| | (A1) (*2) | | | | | | | |
| | Total content | (w/v)% | 0.079 | 0.068 | 0.008 | 0.10 | 0.16 | 0.008 |
| | of saccharides | | | | | | | |
| | (A2) (*3) | | | | | | | |
| | Content of | μg/L | 8.5 | 8.5 | 1.0 | 100.0 | 100.0 | 1.0 |
| | linalool | | | | | | | |
| | Content of | mass ppm | 0.06 | 0.05 | 0.065 | 0.065 | 0.065 | 0.05 |
| | T-VDK | | | | | | | |
| | Total | mass ppm | 145 | 75 | 150 | 152 | 153 | 70 |
| | polyphenol | | | | | | | |
| | amount | | | | | | | |
| | Bitterness | BUs | 24.0 | 24.0 | 12.0 | 29.0 | 29.0 | 5.0 |
| | value | | | | | | | |
| | Malt | mass % | 100 | 50 | 100 | 100 | 100 | 50 |
| | proportion | | | | | | | |
| | Alcohol | (v/v)%/ | 3.70 | 4.30 | 37.00 | 2.87 | 1.85 | 37.00 |
| | content/ | (w/v)% | | | | | | |
| | saccharides | | | | | | | |
| | (A) | | | | | | | |
| | Bitterness | BUs/ | 24.00 | 27.91 | 120.00 | 22.48 | 14.50 | 50.00 |
| | value/ | (w/v)% | | | | | | |
| | saccharides | | | | | | | |
| | (A) | | | | | | | |
| | Linalool/ | μg/ | 8.50 | 9.88 | 10.00 | 77.52 | 50.00 | 10.00 |
| | saccharides | (w/v)% | | | | | | |
| | (A) | | | | | | | |

| | | | | | | | |
|---|---|---|---|---|---|---|---|
| Sensory | Presence or absence | 2.50 | 2.50 | 2.20 | 2.65 | 2.65 | 2.20 |
| evaluation | of drinking sensation | | | | | | |
| | suitable for beer- | | | | | | |
| | taste beverage | | | | | | |
| | Presence or absence | 2.50 | 2.50 | 2.70 | 2.55 | 2.50 | 2.70 |
| | of crispness suitable | | | | | | |
| | for beer-taste | | | | | | |
| | beverage | | | | | | |
| | Presence or absence | 2.50 | 2.50 | 2.50 | 2.50 | 2.50 | 2.50 |
| | of astringency | | | | | | |
| | unsuitable for | | | | | | |
| | beer-taste beverage | | | | | | |
| | Presence or absence | 2.50 | 2.50 | 2.55 | 2.80 | 2.80 | 2.55 |
| | of unripe odor | | | | | | |
| | unsuitable for | | | | | | |
| | beer-taste beverage | | | | | | |
| | Presence or absence | 2.50 | 2.50 | 2.50 | 2.10 | 2.10 | 2.50 |
| | of cosmetic aroma | | | | | | |
| | unsuitable for | | | | | | |
| | beer-taste beverage | | | | | | |
| | Overall evaluation | A | A | B | B | B | B |

| | | | | Compar- | Compar- | Compar- | Compar- |
|---|---|---|---|---|---|---|---|
| | | | | ative | ative | ative | ative |
| | | | Exam- | Exam- | Exam- | Exam- | Exam- |
| | | | ple 14 | ple 5 | ple 6 | ple 7 | ple 8 |
| Property | Alcohol content | (v/v)% | 3.7 | 3.7 | 3.7 | 3.7 | 3.7 |
| of beer- | Total content | (w/v)% | 1.29 | 0.05 | 0.10 | 0.10 | 1.29 |
| taste | of saccharides | | | | | | |
| beverage | (A) (*1) | | | | | | |
| | Total content | (w/v)% | 1.03 | 0.04 | 0.08 | 0.08 | 1.03 |
| | of saccharides | | | | | | |
| | (A1) (*2) | | | | | | |
| | Total content | (w/v)% | 0.10 | 0.004 | 0.008 | 0.008 | 0.10 |
| | of saccharides | | | | | | |
| | (A2) (*3) | | | | | | |
| | Content of | μg/L | 100.0 | 8.5 | 0.0 | 0.0 | 150.0 |
| | linalool | | | | | | |
| | Content of | mass ppm | 0.05 | 0.06 | 0.45 | 0.05 | 0.065 |
| | T-VDK | | | | | | |
| | Total | mass ppm | 78 | 110 | 152 | 105 | 155 |
| | polyphenol | | | | | | |
| | amount | | | | | | |
| | Bitterness | BUs | 29.0 | 15.0 | 12.0 | 5.0 | 29.0 |
| | value | | | | | | |
| | Malt | mass % | 50 | 100 | 100 | 100 | 100 |
| | proportion | | | | | | |
| | Alcohol | (v/v)%/ | 2.87 | 74.00 | 37.00 | 37.00 | 2.87 |
| | content/ | (w/v)% | | | | | |
| | saccharides | | | | | | |
| | (A) | | | | | | |
| | Bitterness | BUs/ | 22.48 | 300.00 | 120.00 | 50.00 | 22.48 |
| | value/ | (w/v)% | | | | | |
| | saccharides | | | | | | |
| | (A) | | | | | | |
| | Linalool/ | μg/ | 77.52 | 170.00 | 0.00 | 0.00 | 116.28 |
| | saccharides | (w/v)% | | | | | |
| | (A) | | | | | | |

| | | | | | | |
|---|---|---|---|---|---|---|
| Sensory | Presence or absence | 2.65 | 1.50 | 2.20 | 2.20 | 2.65 |
| evaluation | of drinking sensation | | | | | |
| | suitable for beer- | | | | | |
| | taste beverage | | | | | |
| | Presence or absence | 2.55 | 2.70 | 2.70 | 2.70 | 2.55 |
| | of crispness suitable | | | | | |
| | for beer-taste | | | | | |
| | beverage | | | | | |
| | Presence or absence | 2.50 | 2.50 | 2.50 | 2.50 | 2.50 |
| | of astringency | | | | | |
| | unsuitable for | | | | | |
| | beer-taste beverage | | | | | |
| | Presence or absence | 2.80 | 2.95 | 1.40 | 1.70 | 2.90 |
| | of unripe odor | | | | | |
| | unsuitable for | | | | | |
| | beer-taste beverage | | | | | |
| | Presence or absence | 2.10 | 2.50 | 2.50 | 2.50 | 1.50 |
| | of cosmetic aroma | | | | | |
| | unsuitable for | | | | | |
| | beer-taste beverage | | | | | |
| | Overall evaluation | B | C | C | C | C |

(*1) Total content of glucose, sucrose, maltose, isomaltose, maltotriose, and isomaltotriose
(*2) Total content of maltose and maltotriose
(*3) Total content of isomaltose and isomaltotriose

TABLE 3

| | | | | | | Compar- | Compar- | | | |
|---|---|---|---|---|---|---|---|---|---|---|
| | | | | | | ative | ative | | | |
| | | | Exam- | Exam- | Exam- | Exam- | Exam- | Exam- | Exam- | Exam- |
| | | | ple 15 | ple 16 | ple 17 | ple 9 | ple 10 | ple 18 | ple 19 | ple 20 |
| Property | Alcohol content | (v/v)% | 1.8 | 1.8 | 1.8 | 1.8 | 1.8 | 4.0 | 4.0 | 4.0 |
| of beer- | Total content | (w/v)% | 0.10 | 1.29 | 2.00 | 0.10 | 1.29 | 0.10 | 1.29 | 2.00 |
| taste | of saccharides | | | | | | | | | |
| beverage | (A) (*1) | | | | | | | | | |
| | Total content | (w/v)% | 0.08 | 1.03 | 1.60 | 0.08 | 1.03 | 0.08 | 1.03 | 1.60 |
| | of saccharides | | | | | | | | | |
| | (A1) (*2) | | | | | | | | | |
| | Total content | (w/v)% | 0.008 | 0.10 | 0.16 | 0.008 | 0.10 | 0.008 | 0.10 | 0.16 |
| | of saccharides | | | | | | | | | |
| | (A2) (*3) | | | | | | | | | |
| | Content of | μg/L | 1.0 | 100.0 | 100.0 | 0.0 | 150.0 | 1.0 | 100.0 | 100.0 |
| | linalool | | | | | | | | | |
| | Content of | mass ppm | 0.02 | 0.02 | 0.02 | 0.35 | 0.02 | 0.07 | 0.10 | 0.10 |
| | T-VDK | | | | | | | | | |
| | Total | mass ppm | 74 | 75 | 79 | 50 | 80 | 160 | 165 | 170 |
| | polyphenol | | | | | | | | | |
| | amount | | | | | | | | | |
| | Bitterness | BUs | 5.0 | 29.0 | 29.0 | 5.0 | 29.0 | 12.0 | 29.0 | 29.0 |
| | value | | | | | | | | | |
| | Malt | mass % | 100 | 100 | 100 | 100 | 100 | 100 | 100 | 100 |
| | proportion | | | | | | | | | |
| | Alcohol | (v/v)%/ | 18.00 | 1.40 | 0.90 | 18.00 | 1.40 | 40.00 | 3.10 | 2.00 |
| | content/ | (w/v)% | | | | | | | | |
| | saccharides | | | | | | | | | |
| | (A) | | | | | | | | | |
| | Bitterness | BUs/ | 50.00 | 22.48 | 14.50 | 50.00 | 22.48 | 120.00 | 22.48 | 14.50 |
| | value/ | (w/v)% | | | | | | | | |
| | saccharides | | | | | | | | | |
| | (A) | | | | | | | | | |
| | Linalool/ | μg/ | 10.00 | 77.52 | 50.00 | 0.00 | 116.28 | 10.00 | 77.52 | 50.00 |
| | saccharides | (w/v)% | | | | | | | | |
| | (A) | | | | | | | | | |

| | | | | | | | | | |
|---|---|---|---|---|---|---|---|---|---|
| Sensory | Presence or absence | 2.25 | 2.70 | 2.70 | 2.25 | 2.70 | 2.20 | 2.60 | 2.65 |
| evaluation | of drinking sensation | | | | | | | | |
| | suitable for beer- | | | | | | | | |
| | taste beverage | | | | | | | | |
| | Presence or absence | 2.70 | 2.55 | 2.50 | 2.70 | 2.55 | 2.70 | 2.55 | 2.50 |
| | of crispness suitable | | | | | | | | |
| | for beer-taste | | | | | | | | |
| | beverage | | | | | | | | |
| | Presence or absence | 2.50 | 2.50 | 2.50 | 2.50 | 2.50 | 2.50 | 2.50 | 2.50 |
| | of astringency | | | | | | | | |
| | unsuitable for | | | | | | | | |
| | beer-taste beverage | | | | | | | | |
| | Presence or absence | 2.55 | 2.80 | 2.80 | 1.60 | 2.90 | 2.55 | 2.80 | 2.80 |
| | of unripe odor | | | | | | | | |
| | unsuitable for | | | | | | | | |
| | beer-taste beverage | | | | | | | | |
| | Presence or absence | 2.50 | 2.10 | 2.10 | 2.50 | 1.50 | 2.50 | 2.10 | 2.10 |
| | of cosmetic aroma | | | | | | | | |
| | unsuitable for | | | | | | | | |
| | beer-taste beverage | | | | | | | | |
| | Overall evaluation | B | B | B | C | C | B | B | B |

| | | | Compar- | Compar- | | | | Compar- | Compar- |
|---|---|---|---|---|---|---|---|---|---|
| | | | ative | ative | | | | ative | ative |
| | | | Exam- | Exam- | Exam- | Exam- | Exam- | Exam- | Exam- |
| | | | ple 11 | ple 12 | ple 21 | ple 22 | ple 23 | ple 13 | ple 14 |
| Property | Alcohol content | (v/v)% | 4.0 | 4.0 | 4.5 | 4.5 | 4.5 | 4.5 | 4.5 |
| of beer- | Total content | (w/v)% | 0.10 | 1.29 | 0.10 | 1.29 | 2.00 | 0.10 | 1.29 |
| taste | of saccharides | | | | | | | | |
| beverage | (A) (*1) | | | | | | | | |
| | Total content | (w/v)% | 0.08 | 1.03 | 0.08 | 1.03 | 1.60 | 0.08 | 1.03 |
| | of saccharides | | | | | | | | |
| | (A1) (*2) | | | | | | | | |
| | Total content | (w/v)% | 0.008 | 0.10 | 0.008 | 0.10 | 0.16 | 0.008 | 0.10 |
| | of saccharides | | | | | | | | |
| | (A2) (*3) | | | | | | | | |
| | Content of | μg/L | 0.0 | 150.0 | 1.0 | 100.0 | 100.0 | 0.0 | 150.0 |
| | linalool | | | | | | | | |
| | Content of | mass ppm | 0.48 | 0.08 | 0.10 | 0.20 | 0.20 | 0.50 | 0.20 |
| | T-VDK | | | | | | | | |
| | Total | mass ppm | 164 | 162 | 186 | 190 | 185 | 187 | 185 |
| | polyphenol | | | | | | | | |
| | amount | | | | | | | | |
| | Bitterness | BUs | 12.0 | 29.0 | 12.0 | 29.0 | 29.0 | 12.0 | 29.0 |
| | value | | | | | | | | |
| | Malt | mass % | 100 | 100 | 100 | 100 | 100 | 100 | 100 |
| | proportion | | | | | | | | |
| | Alcohol | (v/v)%/ | 40.00 | 3.10 | 45.00 | 3.49 | 2.25 | 45.00 | 3.49 |
| | content/ | (w/v)% | | | | | | | |
| | saccharides | | | | | | | | |
| | (A) | | | | | | | | |
| | Bitterness | BUs/ | 120.00 | 22.48 | 120.00 | 22.48 | 14.50 | 120.00 | 22.48 |
| | value/ | (w/v)% | | | | | | | |
| | saccharides | | | | | | | | |
| | (A) | | | | | | | | |
| | Linalool/ | μg/ | 0.00 | 116.28 | 10.00 | 77.52 | 50.00 | 0.00 | 116.28 |
| | saccharides | (w/v)% | | | | | | | |
| | (A) | | | | | | | | |

| | | | | | | | | |
|---|---|---|---|---|---|---|---|---|
| Sensory | Presence or absence | 2.20 | 2.60 | 2.10 | 2.50 | 2.65 | 2.10 | 2.50 |
| evaluation | of drinking sensation | | | | | | | |
| | suitable for beer- | | | | | | | |
| | taste beverage | | | | | | | |
| | Presence or absence | 2.70 | 2.55 | 2.70 | 2.55 | 2.50 | 2.70 | 2.55 |
| | of crispness suitable | | | | | | | |
| | for beer-taste | | | | | | | |
| | beverage | | | | | | | |
| | Presence or absence | 2.50 | 2.50 | 2.50 | 2.50 | 2.50 | 2.50 | 2.50 |
| | of astringency | | | | | | | |
| | unsuitable for | | | | | | | |
| | beer-taste beverage | | | | | | | |
| | Presence or absence | 1.30 | 2.90 | 2.55 | 2.80 | 2.80 | 1.30 | 2.90 |
| | of unripe odor | | | | | | | |
| | unsuitable for | | | | | | | |
| | beer-taste beverage | | | | | | | |
| | Presence or absence | 2.50 | 1.50 | 2.50 | 2.10 | 2.10 | 2.50 | 1.50 |
| | of cosmetic aroma | | | | | | | |
| | unsuitable for | | | | | | | |
| | beer-taste beverage | | | | | | | |
| | Overall evaluation | C | C | B | B | B | C | C |

(*1) Total content of glucose, sucrose, maltose, isomaltose, maltotriose, and isomaltotriose
(*2) Total content of maltose and maltotriose
(*3) Total content of isomaltose and isomaltotriose

As can be seen from Tables 1 to 3, the beverages prepared in Examples 1 to 23 had drinking sensation and crispness suitable for a beer-taste beverage, and had suppressed astringency, unripe odor, and cosmetic aroma unsuitable for a beer-taste beverage. On the other hand, the beverages prepared in Comparative Examples 1 and 5 were inferior in drinking sensation suitable for a beer-taste beverage. In addition, the beverages prepared in Comparative Examples 2, 3, 6, 7, 9, 11, and 13 were beverages in which unripe odor unsuitable for a beer-taste beverage was perceived, and the beverages prepared in Comparative Examples 4, 6, 8, 10, 12, and 14 were beverages in which cosmetic aroma unsuitable for a beer-taste beverage was perceived.

1. A beer-taste beverage having an alcohol content less than or equal to 5.0 (v/v) %, the beer-taste beverage comprising:
as a saccharide, one or more saccharides (A) selected from the group consisting of glucose, sucrose, maltose, isomaltose, maltotriose, and isomaltotriose, wherein a total content of the one or more saccharides (A) is greater than or equal to 0.07 (w/v) %; and
less than or equal to 140 μg/L of linalool.

2. The beer-taste beverage according to claim 1, wherein the total content of the one or more saccharides (A) is less than or equal to 3.00 (w/v) %.

3. The beer-taste beverage according to claim 1, wherein the beer-taste beverage comprises one or more saccharides (A1) selected from the group consisting of maltose and maltotriose, and a total content of the one or more saccharides (A1) is greater than or equal to 0.05 (w/v) % and less than or equal to 2.40 (w/v) %.

4. The beer-taste beverage according to claim 3, wherein the total content of the one or more saccharides (A1) is greater than or equal to 0.30 (w/v) % and less than or equal to 2.40 (w/v) %.

5. The beer-taste beverage according to claim 1, wherein a content of T-VDK is less than or equal to 0.300 mass ppm.

6. The beer-taste beverage according to claim 1, wherein a bitterness value of the beer-taste beverage is greater than or equal to 1.0 BUs and less than or equal to 40.0 BUs.

7. The beer-taste beverage according to claim 1, wherein a bitterness value of the beer-taste beverage is less than 35.0 BUs.

8. The beer-taste beverage according to claim 1, wherein a ratio [alcohol content/saccharides (A)] of the alcohol content (in (v/v) %) to the total content of the one or more saccharides (A) (in (w/v) %) is from 0 to 70.0.

9. The beer-taste beverage according to claim 1, wherein a ratio [linalool/saccharide (A)] of the content (in ug/L) of linalool to the total content (in (w/v) %) of the one or more saccharides (A) is greater than or equal to 1 and less than or equal to 160.

10. The beer-taste beverage according to claim 1, wherein a ratio [bitterness value/saccharides (A)] of the bitterness value (in BUs) to the total content of the one or more saccharides (A) (in (w/v) %) is greater than or equal to 1 and less than or equal to 200.

11. The beer-taste beverage according to claim 1, wherein a malt proportion of the beer-taste beverage is greater than or equal to 50 mass % and less than or equal to 100 mass %.

12. The beer-taste beverage according to claim 1, wherein the alcohol content is less than or equal to 4.5 (v/v) %.

13. The beer-taste beverage according to claim 1, wherein the alcohol content is less than or equal to 4.0 (v/v) %.

14. The beer-taste beverage according to claim 1, wherein the alcohol content is greater than or equal to 0.5 (v/v) %.

15. A method for producing a beer-taste beverage, the method comprising at least:
(I): adjusting an alcohol content to less than or equal to 5.0 (v/v) %;
(II): using, as a saccharide, one or more saccharides (A) selected from the group consisting of glucose, sucrose, maltose, isomaltose, maltotriose, and isomaltotriose, and adjusting a total content of the one or more saccharides (A) to greater than or equal to 0.07 (w/v) %; and
(III): adjusting a content of linalool to less than or equal to 140 μg/L.

16. A method for improving a flavor of a beer-taste beverage, the method comprising at least:
operation (I): an operation of adjusting an alcohol content to less than or equal to 5.0 (v/v) %;
operation (II): an operation of using, as a saccharide, one or more saccharides (A) selected from the group consisting of glucose, sucrose, maltose, isomaltose, maltotriose, and isomaltotriose, and adjusting a total content of the one or more saccharides (A) to greater than or equal to 0.07 (w/v) %; and
operation (III): an operation of adjusting a content of linalool to less than or equal to 140 μg/L.
